(19) United States
(12) Patent Application Publication
(10) Pub. No.: US 2025/0204565 A1
(43) Pub. Date: Jun. 26, 2025

(54) PLANT-ONLY MODIFIED STARCH REPLACEMENT SYSTEM IN FOOD PRODUCTS

(71) Applicant: The Live Green Group, Inc.,, Middletown, DE (US)

(72) Inventors: Sasikanth Chemalamudi, San Fernando (CL); Priyanka Srinivas, San Fernando (CL)

(21) Appl. No.: 18/849,576

(22) PCT Filed: Apr. 13, 2023
(86) PCT No.: PCT/IB2023/053781

§ 371 Date: Sep. 23, 2024

Related U.S. Application Data
(63) Continuation of application No. 63/333,847, filed on Apr. 22, 2022.

(51) Int. Cl. A23L 29/212

(52) U.S. Cl. CPC A23L 29/212

(57) ABSTRACT

The present disclosure discloses a plant-only composition for a food product. The plant-only composition comprises (i) about 1% to about 20% weight by weight of one or more legume starch sources, (ii) about 20% to about 60% weight by weight of one or more vegetable starch sources, (iii) about 5% to about 25% weight by weight of one or more cereal starch sources, and (iv) about 1% to about 20% weight by weight of one or more seed starch sources. The plant-only composition substitutes a starch ingredient in the food product. The food product comprises animal-based burger products, plant-based or plant-derived burger products, burger mixes, meat-based food products, meat alternative food products, frozen food products, baked food products, ice cream and other frozen food products, chocolate, fried food products, and food product mixes.

### CROSS-REFERENCE TO RELATED APPLICATIONS

This application claims to the U.S. Provisional Patent Application No. 63/333,847, filed on Apr. 22, 2022 and PCT Patent Application No. PCT/IB2023/053781, filed on Apr. 13, 2023, titled “PLANT ONLY MODIFIED STARCH REPLACEMENT SYSTEM IN FOOD PRODUCTS” and is incorporated herein by reference.

### BACKGROUND

### Technical Field

The present disclosure relates to a plant-only composition, and more particularly, relates a plant-only modified starch replacement system that replaces chemical, synthetic and/or highly processed modified starch additives in commercially available food products such as animal-based or plant-based burgers products, burger mixes, other meat-based products, meat alternative products, frozen food products, baked goods, ice cream and other frozen foods, chocolate, fried foods, and other food products, including food product mixes. Such plant-only replacements are minimally processed and are free of synthetic food additives. The present disclosure also relates to a food product comprising a plant-only composition.

### Description of the Related Art

Many commercially available, processed plant-based and animal-based food products contain natural and/or synthetic food additives as well as other highly processed ingredients. The categories of commercially available food products containing such additives vary greatly, and include animal flesh-based (i.e., one or more types of beef, pork, poultry, fish, shellfish, other seafood, etc.) or imitation meat-containing products based in whole or in part on plant derived materials, including food products comprised of a combination of both animal-source and plant-sourced (or other) materials. As an example, these food products may be, in one form, commercially available burgers and burger mixes, patties, cakes, crumbles, etc. Additives are found in all types of commercially available food products, and serve as stabilizers, preservatives, colorants, flavor enhancers, sweeteners, thickeners, texturizers, and emulsifiers, and provide a variety of desired characteristics such as flavors, textures, appearance, and consistency. Additives can maximize yield, minimize shrinkage and cooking loss, and/or lead to more uniform blending or homogeneity to the food product or food product mix.

Together, all of the meat-based and/or plant-based meat alternative food products available commercially in any form will be referred to as “Traditional Burger Products,” despite their origin or form. These are distinguished from the plant-only (non-animal-sourced) food products of all types including burgers and burger mixes, collectively, plant-only “burger products,” as well as the plant-only modified starch replacement system of the disclosed embodiments. These terms are discussed in more detail and the categories distinguished further below.

Commercially available, traditional burger products are generally highly processed foods. Traditional, meat-based burgers contain meat or animal flesh of some kind, added saturated fats, bone (carcass), highly processed ingredients, synthetic additives and other ingredients that may be inappropriate for certain diets, e.g., vegetarian, salt-restricted, low-fat, low saturated fat, culturally- or religiously-restricted diets etc. Even some commercially available “plant-based,” “plant-derived,” “meatless,” and “meat-free” burgers and other food products (depending on how those terms are defined by the manufacturers, or under definitions supported by a governmental regulatory authority in the country of manufacture) may contain animal-derived ingredients such as bone and meat broth or gelatin, dairy products and certain saturated fats, sourced from animals slaughtered for food, or from animals raised primarily for dairy product production. Such animal-derived additions can render even these “plant-based” burgers and burger mixes inappropriate for vegetarians.

Some meat substitutes have been developed, in part, to mimic the qualities that some consumers of plant-based alternatives desire in a burger: a juicy center, red color and meaty (or umami) taste but often a significant amount of saturated fat must be added to achieve a desired consistency or texture. Food additives in traditional burger products may have physiological effects and many consumers do not want or do not want to risk if a healthier, more sustainable alternative is available that does not pose the downsides. Examples of food additives commonly found in traditional burger products and other food products include silicon dioxide, sodium benzoate, sodium nitrite, and artificial food colors. Others include guar gum, modified starches, polydextrose and mannitol. Many such additives (particularly synthetic additives) can be harmful to consumers if consumed over prolonged periods. The food industry uses more than 7,000 synthetic and ultra-processed additives even though nature offers more than ten million compounds from more than 450,000 plants. Over the past decade, the development of the ultra-processed food industry has required the use of chemical additives such as modified starches.

Native starches may not be suitable for use in the food industry. Food grade modified starches are produced by a derivatization process applied to these native starches, improving their functionality for a variety of applications including without limitation, emulsifiers, stabilizers, texturizers, thickeners, drying agents, binders, clouding agents, suspending agents and for freeze-thaw stability and gelling agents in food products. The most common types of modified starches are made from corn (maize), wheat, potato, and tapioca. Almost all commercially available processed foods contain some amount of modified starch.

It would be desirable to provide solely plant-derived or fungi-derived (hereafter, “plant-only,” as further defined below) ingredients that replace typical, synthetic, artificial and/or animal-derived (i.e., sourced directly or indirectly from an animal) modified starch ingredients found in meats products and meat substitute products such as traditional burger products, as well as in breads and other baked goods. A “plant-only” food product is free from dairy and other animal-derived ingredients and is minimally processed, with—or, as a component of another food product, contributing to—a desirable flavor, taste, texture, homogeneity, consistency, color and appearance so as to be aesthetically pleasing prior to consumers.

Thus, there is a need for a plant-only composition for a food product to substitute the conventional starch ingredient in the food product.

### SUMMARY

In view of the foregoing, embodiments herein provide a plant-only composition for a food product. The plant-only composition comprises (i) about 1% to about 20% weight by weight of one or more legume starch sources, (ii) about 20% to about 60% weight by weight of one or more vegetable starch sources, (iii) about 5% to about 25% weight by weight of one or more cereal starch sources, and (iv) about 1% to about 20% weight by weight of one or more seed starch sources. The plant-only composition substitutes a starch ingredient in the food product.

In some embodiments, the one or more legume starch sources comprises pea starch, lupine starch, faba bean starch/protein, red lentils starch, lima bean, navy bean, mung bean, black gram flour, lentils flour, garbanzo bean, yellow pea flour, or a combination thereof. In some embodiments, the pea starch comprises about 40% weight by weight of starch and has a neutral color and taste. The pea starch acts as a thickener, an emulsifier, and a gelling agent in the food product as it resists breakdown in high temperatures and its amylose content contributes to water retention properties. In some embodiments, the one or more legume starch sources present in the plant-only composition ranges from about 5% to about 15% weight by weight of the composition.

In some embodiments, the one or more legume starch sources present in the plant-only composition ranges from (i) about 1% to about 5% weight by weight of the composition, (ii) about 2% to about 7% weight by weight of the composition, (iii) about 5% to about 10% weight by weight of the composition, (iv) about 5% to about 15% weight by weight of the composition, (v) about 8% to about 13% weight by weight of the composition, (vi) about 10% to about 20% weight by weight of the composition, (vii) about 14% to about 19% weight by weight of the composition, (viii) about 15% to about 20% weight by weight of the composition, or (ix) about 17% to about 20% weight by weight of the composition.

In some embodiments, the one or more legume starch sources has a pH of about 5 to 8, a peak viscosity of about 1107 to about 2173 Centipoise (cP), a water holding capacity of about 1.81 to about 2.63 gallons water per gram (g water/g), an amylose content of about 30.61% to about 33.55%, a swelling power of about 1.05 to about 21 g/g depending on the temperature, a moisture content of about 15%, a granule size of about 2 to about 40 micrometres (m), a crystallinity of about 18.9% to about 36.5%, and a gelatinization/pasting temperature of about 60° C. to about 80° C.

In some embodiments, the one or more vegetable starch sources comprises at least one of potato starch, cassava starch, tapioca starch, mushroom flour, bamboo starch, sweet potatoes, beets starch, acorn squash starch, pumpkin starch, butternut squash, hubbard starch, or a combination thereof. In some embodiments, the potato starch comprises about 22% weight by weight of amylose content and acts as a gelling agent in the food product. In some embodiments, the one or more vegetable starch sources present in the plant-only composition ranges from about 30% to about 50% weight by weight of the composition.

In some embodiments, the one or more vegetable starch sources present in the plant-only composition ranges from (i) about 20% to about 30% weight by weight of the composition, (ii) about 30% to about 40% weight by weight of the composition, (iii) about 30% to about 50% weight by weight of the composition, (iv) about 40% to about 50% weight by weight of the composition, or (v) about 50% to about 60% weight by weight of the composition.

In some embodiments, the one or more vegetable starch sources has a pH of about 6 to 8, a bulk density of about 700 kilogram/cubic meter (kg/cc), a moisture content of about 20%, a peak viscosity of about 0.1 to about 0.9 pascal seconds at a shear rate of 115 inverse second (s⁻¹), a water holding capacity of about 415.13% to about 595.26%, an amylose content of about 15% to about 30%, a swelling power of about 20.76% to about 26.92%, a crystallinity ranging from about 20.33% to about 22.25%, and a gelatinization/pasting temperature of about 68.6° C. to about 69.3° C.

In some embodiments, the one or more cereal starch sources comprises at least one of sorghum starch, maize starch, wheat starch, barley starch, pearl millet starch, ragi flour, finger millet starch, rice starch, oats starch, rye flour, or a combination thereof. In some embodiments, the sorghum starch comprises more than 25% weight by weight of amylose content and acts as a thickener or a gelling agent in the food product. In some embodiments, the one or more cereal starch sources present in the plant-only composition ranges from about 10% to about 20% weight by weight of the composition.

In some embodiments, the one or more cereal starch sources present in the plant-only composition ranges from (i) about 5% to about 10% weight by weight of the composition, (ii) about 7% to about 12% weight by weight of the composition, (iii) about 10% to about 20% weight by weight of the composition, (iv) about 12% to about 17% weight by weight of the composition, (v) about 17% to about 22% weight by weight of the composition, or (vi) about 22% to about 25% weight by weight of the composition.

In some embodiments, the one or more cereal starch sources has a swelling power of about 3.3 to about 8.8 g/g, a bulk density of about 513.30 to about 585.10 grams per litre (g/l), a peak viscosity of about 1296 to about 3348 Centipoise (cP), a water holding capacity of about 2.42 to about 3.35 gallons water per gram (g water/g), an amylose content of about 14% to about 30%, a gelatinization/pasting temperature of about 68° C. to about 72° C., and a gelatinization time of about 16.59 minutes to about 19 minutes.

In some embodiments, the one or more seed starch sources comprises at least one of quinoa starch, amaranth starch, moringa seed flour, canary seed starch, chia seeds, poppy seeds flour, annatto seed flour, pistachio seed hull flour, sunflower seeds starch, date palm seeds starch, or a combination thereof. In some embodiments, the quinoa starch comprises antioxidants, proteins, and unsaturated fatty acids and acts as a gel, foam or an emulsifier in the food product. In some embodiments, the one or more seed starch sources present in the plant-only composition ranges from about 5% to about 15% weight by weight of the composition.

In some embodiments, the one or more seed starch sources present in the plant-only composition ranges from (i) about 1% to about 5% weight by weight of the composition, (ii) about 2% to about 7% weight by weight of the composition, (iii) about 5% to about 10% weight by weight of the composition, (iv) about 5% to about 15% weight by weight of the composition, (v) about 8% to about 13% weight by weight of the composition, (vi) about 10% to about 20% weight by weight of the composition, (vii) about 14% to about 19% weight by weight of the composition, (viii) about 15% to about 20% weight by weight of the composition or (ix) about 17% to about 20% weight by weight of the composition.

In some embodiments, the one or more seed starch sources has a swelling power of about 2.05 to about 4.85 g/g, a water holding capacity of about 1.81 to about 2.63 gallons water per gram (g water/g), an amylose content of about 16% to about 30.8%, a gelatinization/pasting temperature of about 54° C. to about 71° C., a bulk density of about 738 to about 842 kilograms per meter cube (kg/m³), a hardness value of about 20.8 grams, a moisture content of about 4.6% to about 25.8%, and a peak viscosity of about 1000 to about 2400 Centipoise (cP).

In some embodiments, the food product comprises animal-based burger products, plant-based or plant-derived burger products, burger mixes, meat-based food products, meat alternative food products, frozen food products, baked food products, ice cream and other frozen food products, chocolate, fried food products, and food product mixes. In some embodiments, the plant-only composition acts as a texturizing agent and a volume enhancers in the food product and replaces conventional, non-plant-derived, synthetic or processed additive and ingredient in the food product.

In some embodiments, the plant-only composition replaces one or more additives in the food product and maintains structure and texture in the food product by (i) increasing water retention capacities, (ii) increasing pasting, (iii) improving resistance to retrogradation, and (iv) improving stabilization during freezing and thawing cycles. In some embodiments, the plant-only composition, when combined with a binding agent comprising at least one of hydrocolloids, protein and vegetable fibers, produces a resilient matrix to maintain its shape, texture and palatability when heated.

In one aspect, the plant-only composition is provided. The plant-only composition comprises (i) about 5% to about 15% weight by weight of one or more legume starch sources, (ii) about 30% to about 50% weight by weight of one or more vegetable starch sources, (iii) about 10% to about 20% weight by weight of one or more cereal starch sources, and (iv) about 5% to about 15% weight by weight of one or more seed starch sources. The plant-only composition substitutes a starch ingredient in the food product.

In some embodiments, the plant-only composition comprises (i) about 5% to about 15% weight by weight of pea starch, (ii) about 30% to about 50% weight by weight of potato starch, (iii) about 10% to about 20% weight by weight of sorghum starch, and (iv) about 5% to about 15% weight by weight of quinoa starch. The plant-only composition substitutes a starch ingredient in the food product.

In some embodiments, the plant-only composition present in the food product ranges from about 5% to 15% weight by weight of the food product. In some embodiments, the plant-only composition present in the food product ranges from about 0.5% to about 30% weight by weight of the food product depending on the moisture content of the plant-only composition and that of the final food product. In some embodiments, the plant-only composition present in the food product ranges from about 0.01% to about 1% weight by weight of the food product.

In another aspect, a food product is provided. The food product comprises about 10% to about 15% weight by weight of a plant-only composition. The plant-only composition comprises (i) about 1% to about 20% weight by weight of one or more legume starch sources, (ii) about 20% to about 60% weight by weight of one or more vegetable starch sources, (iii) about 5% to about 25% weight by weight of one or more cereal starch sources, and (iv) about 1% to about 20% weight by weight of one or more seed starch sources. The plant-only composition substitutes a starch ingredient in the food product.

In some embodiments, the food product comprises (i) about 10% to about 20% weight by weight of one or more protein sources, (ii) about 5% to about 10% weight by weight of a plant-derived methyl cellulose replacement composition, (iii) about 10% to about 12% weight by weight of one or more plant-derived oils, (iv) about 10% to about 15% weight by weight of a plant-derived gums and carrageenan replacement composition, and (v) about 0.5% to about 1% weight by weight of a plant-derived leavening agent replacement composition.

In some embodiments, the food product comprises (i) about 1% to about 2% weight by weight of one or more plant-derived shelf life extenders, (ii) about 0.5% to about 2% weight by weight of a plant-derived umami flavor, (iii) about 0.5% to about 1% weight by weight of one or more plant-derived flavorants/flavor enhancers, or nutraceuticals, (iv) about 1% to about 2% weight by weight of a second plant-derived flavor enhancer, (v) about 0.5% to about 2% weight by weight of one or more mineral salts, (vi) about 5% to about 10% weight by weight of one or more plant-derived binding agents, (vii) about 1% to about 2% weight by weight of one or more plant-derived leghemoglobin source, and (viii) about 0.5% to about 2% weight by weight of one or more plant-derived lipid peroxidation inhibitors.

In some embodiments, the one or more protein sources comprises at least one of pea, mushroom, quinoa, chickpeas, or a combination thereof. In some embodiments, the plant-derived methyl cellulose replacement composition comprises at least one of proteins, fibers from whole grains, fruits, seeds, vegetables, starches, vegetable binders, or a combination thereof. In some embodiments, the one or more plant-derived oils comprises at least one of sunflower oil, coconut oil, flaxseed oil, rice bran oil, other oil comprising at least one of Omega-3 fatty acids, Monounsaturated fatty acids (MUFA), or Medium-chain triglycerides (MCTs), or a combination thereof. In some embodiments, the plant-derived gums and carrageenan replacement composition comprises at least one of quince seed, apple, mesquite, almonds, or a combination thereof.

In some embodiments, the plant-derived leavening agent replacement composition comprises at least one of plant-derived fibers, fruit pectin, fruit acids, plant-derived starches, cereal sources, or a combination thereof. In some embodiments, the plant-derived leavening agent replacement composition comprises at least one of plum powder, apple cider vinegar, vegan buttermilk, or a combination thereof.

In some embodiments, the one or more plant-derived shelf life extenders comprises at least one of garlic, black pepper, oregano, bay laurel, or a combination thereof, wherein the plant-derived umami flavor comprises at least one of shitake and other mushrooms, tomatoes, garlic, lotus stalk, onions, salt, or a combination thereof. The one or more plant-derived flavorants/flavor enhancers, or nutraceuticals comprises at least one of cumin, coriander, paprika, black pepper, or a combination thereof, wherein the second plant-derived flavor enhancer comprises at least one of nutritional yeast, cashew nuts, or a combination thereof. The one or more mineral salts comprises at least one of Himalayan pink salt, sea salt, or a combination thereof. The one or more plant-derived binding agents comprises at least one of chickpeas, oat fiber, aquafaba, sugar beet pectin, or a combination thereof. The one or more plant-derived leghemoglobin sources comprises at least one of beets, soy, red radish, or a combination thereof. The one or more plant-derived lipid peroxidation inhibitors comprises at least one of black pepper, bay leaf, cumin, or a combination thereof.

In yet another aspect, a plant-only modified starch replacement system for a food product comprising a plant-only composition is provided. The plant-only composition comprises (i) about 1% to about 20% weight by weight of one or more legume starch sources, (ii) about 20% to about 60% weight by weight of one or more vegetable starch sources, (iii) about 5% to about 25% weight by weight of one or more cereal starch sources, and (iv) about 1% to about 20% weight by weight of one or more seed starch sources. The plant-only composition substitutes a starch ingredient in the food product.

The plant-only composition can be used as an alternative/substitute for starch ingredient in the food products, for example, burgers products, burger mixes, baked goods, frozen food products, etc. The plant-only composition replaces conventional starch ingredients in food products that consists of minimally processed, plant-derived ingredients while ensuring desirable flavor, texture, appearance and taste as well as the same or similar functionality of conventional starch ingredients for the food product to which the composition is incorporated.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications. Further, one skilled in the relevant art will recognize that the embodiments can be practiced without one or more of the specific details or with other methods, components, materials and so forth. In other instances, well-known structures, materials, or operations are not shown in detail to avoid obscuring the features of the embodiments. Furthermore, the features/aspects described can be practiced in various combinations, though only some of the combinations are described herein for conciseness.

### BRIEF DESCRIPTION OF THE DRAWINGS

The embodiments herein will be better understood from the following detailed description with reference to the drawings, in which.

FIG. 1 illustrates a plant-only composition for a food product according to some embodiments herein; and

FIG. 2 illustrates a flow diagram of a process of preparing a plant-only composition for a food product according to some embodiments herein.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments.

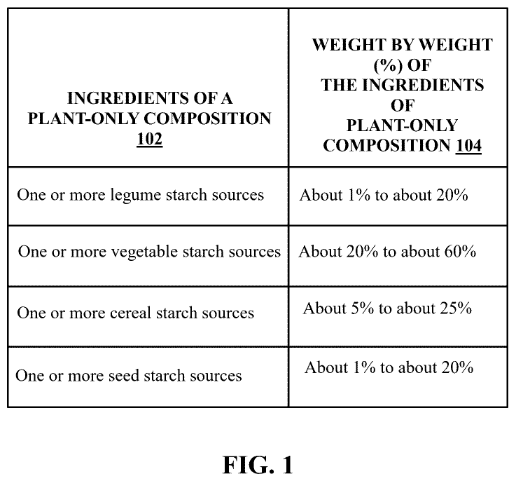

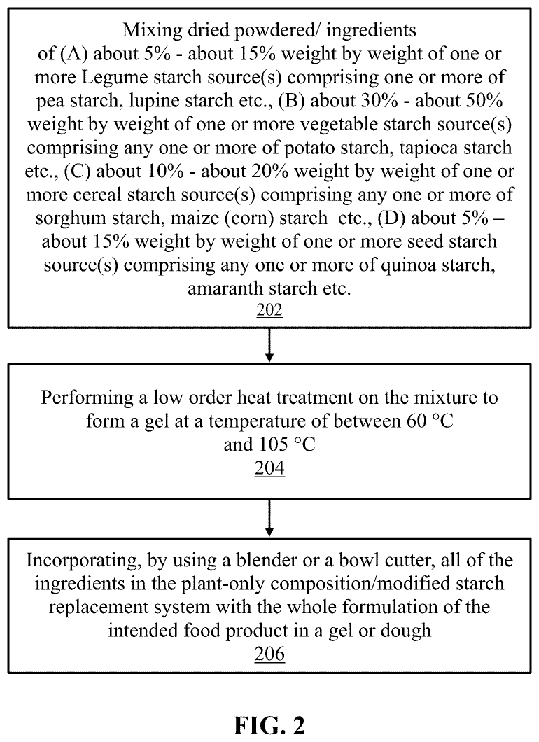

Referring now to the drawings, and more particularly to FIGS. 1 through 2, where similar reference characters denote corresponding features consistently throughout the figures, there are shown preferred embodiments.

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

The terms “comprising”, “comprises” and “comprised of” as used herein are synonymous with “including”, “includes” or “containing”, “contains”, and are inclusive or open-ended and do not exclude additional, non-recited members, elements or method steps.

The Applicant, Live Green Company, is the market maker of the Plant-only category, which means that all the animal, synthetic and ultra-processed ingredients are replaced by plant-derived ingredients with superior nutritional profiles without impacting the original organoleptic properties.

Aspects of the disclosure are provided herein for a plant-only composition and components thereof to be used in place of commercially available, (frequently) chemically, enzymatically or physically modified starches and other additives in a variety of food products. The selection of plant-derived ingredients and combinations of ingredients selected by a Charaka machine learning system provide effective functionalities for leavening agents in food products, including meat substitutes. Commercially available, meat-based and/or imitation meat based food products such as highly processed plant-only, meatless or meat-free burgers, burger mixes and other types of imitation meats and meat-alterative products (together, “Traditional Burger Products”) are one category of food products that can benefit from substitution of modified starches and other traditional additives for plant-derived ingredients and additives that are minimally processed. In the disclosed embodiments of the plant-only composition, plant-derived ingredients effectively function as texturizing agents and volume enhancers in food products, replacing the conventional, non-plant-derived, synthetic or highly processed additives and ingredients normally found in Traditional Burger Products and other commercially available food products. In the disclosed embodiments, plant-only composition (or replacement systems) are comprised of only minimally processed, naturally occurring (i.e., non-synthetic) ingredients sourced solely sources outside of the animal kingdom, e.g., from plants, fungi, or algae.

Modified starches are produced (derivatized) from native starches in some cereals such as wheat and corn (maize), and tubers, such as potatoes. The native starches are chemically, physically or enzymatically treated to create “bridges” between the starch chains, promoting stability, mainly during freezing and thawing cycles. These modifications ensure repulsion between starch chains, preventing recombination, and starch retrogradation is minimized. Some modified starches may be cold-water soluble for use in pregelatinized or “instant” food products to which cold water is added. These starches thicken and gel the food products without the need for heat. Gelatinization of native starches takes place when heat is added to a liquid solution containing these starches. Intermolecular bonds within the starch molecules are broken, permitting gelling of these starches, an important property for food products that require certain texturizing, thickening and increasing palatability. Starch granules swell during this process causing crystallite melting, increases in viscosity and solubilization. The food industry has promoted modification of native starches for use in processed foods. When these are combined with binding agents such as hydrocolloids, protein and vegetable fibers, a resilient matrix results that maintains its shape, texture and palatability when heated.

Embodiments disclosed herein include the plant-only modified starch replacement system, or components of it, for replacing various ingredients or combinations of ingredients traditionally found in commercially available food products, including Traditional Burger Products. In some embodiments the modified starch replacement system or aspects of the system replace part of the meat or fibrous material as well as the additives of a (meat-based or plant-derived) Traditional Burger Product. In other embodiments, the modified starch replacement system or components of it complement the ingredients of plant-based or plant-derived Traditional Burger Products, by providing more plant-only protein and non-synthetic additive sources that enhance the nutritional value of the food product. In still other embodiments the modified starch replacement system replaces all animal-derived ingredients of, so-called “plant-derived,” “plant-based” or meatless, imitation meat food products, including food product mixes.

The “Plant-only” products disclosed herein, as opposed to products labeled as “plant-based,” “meatless,” “meat-free” and the like, refer to food products whose ingredients, apart from any significant amount of water added, are derived solely from sources outside of the animal kingdom, e.g., from plants, fungi, or algae. That is, “plant-only” may refer to any composition, formulation, system or a food product, that is produced, developed, or otherwise obtained directly or indirectly from one or more plants, fungi, or algae, is not synthetic, and is only minimally processed for production, e.g., cleaned, dried, pulverized, etc.

While some manufacturers may refrain from including any ingredients sourced from animals in their “plant-based” (and other similarly labeled) products, the term “plant-based” may also encompass ingredients and food products that may be obtained from animals. The US Food and Drug Administration currently has no accepted standard definition for labeling of food products described as “plant-based” although a private trade organization, the Plant Based Food Association, has proposed voluntary standards to ensure consistency when the term “plant-based” is used on a product label (i.e., it contains no animal-sourced content), and seeks to certify—through its own certification process—food products, including food product mixes, that meet this standard See https://www.plantbasedfoods.org/policy/labeling/. The terminology used on a label for a plant-based food must be truthful under FDA regulations; however, in the US, no regulatory body currently requires a company to refrain from including some amount of meat, seafood, or other animal-sourced ingredients in a “plant-based” product.

The term “food product” refers broadly to any edible good or product, raw or cooked, savory or sweet, whether intended for human or animal consumption; a food product may be edible although not intended to be consumed on its own but, rather, incorporated into a second (or third) food product that is considered a consumable. The plant-only composition disclosed herein in certain embodiments may be incorporated into or used with meat-based food products; in other embodiments it may be incorporated into or used with seafood-based food products; in still other embodiments, it may be incorporated into or used with plant-based food products. In certain preferred embodiments, the plant-only composition may be incorporated into or used with plant-only food products, including burgers products, burger mixes, baked goods, frozen food products, etc.

In certain embodiments, while some of the water content of a food product may be derived from a plant source, water may also be added to the product from an external source. For example, in scenarios in which a plant-only system or composition or plant-only food product is in the form of a gel or liquid, it is further understood that water can be included as solvent or liquid carrier for the plant-only composition, system or food product, where any amount of water (some or all) within the composition, system or food product may or may not be derived from a plant source. Further, the plant-derived “agents”, “component” or “ingredients” can be fresh sourced (i.e., obtained from a particular plant source with no processing). Alternatively, the plant-derived ingredients can be minimally processed such as in ways described herein (e.g., freeze dried, pulverized or pureed, extracted from a fresh sourced portion of a plant, etc.). In some embodiments, water may be added from an external source as part of the plant-only composition (or any other plant-derived component, agent or ingredient referenced herein). In other embodiments the plant-only composition may be available in a dried form; in certain embodiments the dried form may be powdered; in other embodiments, the dried form of the plant-only composition may be in a partially powdered form; in other embodiments it may be available in a semi-liquid or gel form; in other embodiments it may be in a liquid or frozen form.

In the disclosed embodiments, apart from externally-sourced water, the plant-only food product consists entirely of ingredients derived from plants, fungi or algae, excluding any component or ingredient that is: (i) starch-based or otherwise derived from any member of the animal kingdom; and (ii) more than minimally processed; and (ii) synthetic. In some embodiments, the plant-only composition, or components thereof, replace conventional ingredients and additives found in meat-based food products such as commercially available meat-based burgers. In other embodiments the plant-only composition replaces those additives found in commercially available plant-based, plant-derived, meatless, meat-free food products that range from burgers products, burger mixes, baked goods, and frozen food products.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, regardless of whether it is expressly described herein, one of ordinary skill in the art would readily appreciate that each of the particular features, structures, or characteristics of the given embodiments may be utilized in connection or combination with those of any other embodiment discussed herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, i.e., edible compounds sourced from plants, fungi or algae that comprises one or more naturally occurring chemical compounds. Selection of specific plant-derived ingredients, or specific combinations of plant-only or plant-derived ingredients, provide effective functionalities for starch replacement additives in a food product (e.g., a plant-only food product). As used herein, the term “component” or “ingredient” refers to a particular item that includes one or more chemical compounds (e.g., a food/edible parts from the plant species that comprises one or more naturally occurring chemical compounds).

In example embodiments, the plant-only food product includes a combination of components or ingredients from the plant genus that render the combination (in the amounts as indicated) particularly suitable as a starch replacement agent or composition for a food product. In such embodiments, the plant-only modified starch replacement system is added to other food ingredients to form a final food product formulation that requires such starch replacement composition/system. Examples of food products that utilize starch replacement additives include, without limitation, dessert like products such as burgers products, burger mixes, baked goods, frozen food products, etc.

### Charaka Machine Learning (ML) Platform and the Ancestral Wisdoms Data System

In general, the selection of a specific combination of ingredients for plant-only composition/products/systems is determined using a proprietary machine learning (ML) platform, which blends ancestral wisdoms of plant nutrition with biotechnology and ML to analyze members of, primarily, the plant and fungi kingdoms, as well as other potential, natural, sources outside of the animal kingdom for the compound nature offers. The platform utilizes algorithms and includes a database with a significant number of ingredients (e.g., 50,000-100,000 ingredients) and relevant physical properties associated with such ingredients. For example, physical characterization data and information about each ingredient for some or all of the ingredients in the database include, without limitation, functional properties (e.g., emulsification properties, stabilization properties, bulking properties, texturizing properties, gelling properties, starch-replacement properties, etc.). Ayurvedic and/or other properties derived from ancestral wisdom, physicochemical properties (e.g., pH, viscosity, moisture content, density, etc.), mechanical properties (e.g., adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability. Based upon the known properties of ingredients in the database, the desired properties for the food product or formulation, and one or more algorithms associated with the proprietary machine learning platform, a unique combination of plant-derived ingredients is determined to yield an effective starch replacement system/plant-only composition that can be used to form a desirable food product or formulation that is effective as a substitute for conventional starch ingredients in Traditional Burger Products or for providing modified starch-like functionality in plant-only burger products and other food products.

As noted, the proprietary system identifies natural alternatives, i.e., as defined, “plant-derived” alternatives to synthetic, artificial, and animal-derived ingredients, and incorporates in its algorithms, among other things, ancestral or traditional knowledge from systems such as Ayurvedic medicine. Ayurvedic medicine and its diet principles have been practiced for many thousands of years. This ancient system, among other things, categorizes food by its medicinal properties and desired effects; thus, the proper application of Ayurvedic principles requires knowledge of the self—one's dominant energy, also known as dosha—to prescribe the most advantageous categories of foods from which to choose for an individual's diet. Categories of Ayurvedic properties include but are not limited to Virya (hima/sheeta—cold), Vipaka (Madhura—sweet), Rasa (Madhura—sweet), and Guna (ruksa—dry; or guru—heavy). Such similar ancestral wisdoms exist in other parts of the world such as the Traditional Chinese Medicine, Amazonian rainforest ancestral wisdom which may also be used as part of Charaka. The information recommended by the proprietary Charaka system permits one to choose among hundreds of alternatives based on ingredients intended to alter a variety of properties to give optimal results for starch replacement purposes as well as physiological functionality, health, and environmental sustainability.

A food product as described herein that functions to replace starch ingredient in Traditional Burger Products or plant-only burger products comprises a combination of solely plant-sourced or fungi-sourced ingredients and added water, if any is required for their preparation. The plant-derived ingredients and combinations of ingredients selected for the plant-only modified starch replacement system are consistent with the requirements and specifications of achieving the functionalities exhibited by conventional modified starch, when used in food products containing meat substitutes.

### Terms and Definitions

As used in the present invention, the following terms are generally intended to have the meaning as set forth below, except to the extent that the context in which they are used indicate otherwise.

Starch: Starch refers to agranular, organic chemical that is produced by green plants. It is a polymeric carbohydrate consisting of numerous glucose units joined by α-D glycosidic bonds.

Protein: Proteins are large biomolecules and macromolecules that comprise one or more long chains of amino acid residues.

Gel: A gel is a semi-solid that can have properties ranging from soft and weak to hard and tough. Gels are defined as a substantially dilute cross-linked system, which exhibits no flow when in the steady-state, although the liquid phase may still diffuse through this system.

Thickener: Thickener refers to a substance which can increase the viscosity of a liquid without substantially changing its other properties.

Emulsifier: Emulsifier is an additive that enables the suspension of one liquid in another.

Gelling Agent: Gelling Agent refers to a gel-forming agent (e.g., hydrocolloids) which, when dissolved in a liquid phase as a colloidal mixture, forms a weakly cohesive internal structure.

Swelling Power: Swelling Power refers to water holding capacity of starch, which has generally been used to demonstrate differences between various types of starches.

Crystallinity: Crystallinity refers to a degree of structural order of a solid.

Gelatinization temperature: Gelatinization temperature is a temperature at which the gelatinization is complete.

Pasting temperature: Pasting temperature is a temperature at which the viscosity begins to increase during the heating process.

Moisture content: Moisture content refers to a quantity of water contained in a material/substance.

Bulk Density: Bulk density is a weight of a volume unit of powder and is usually expressed in g/cm3, kg/m3, or g/100 ml.

Gelatinization time: Gelatinization time is the time taken for chemical reaction involving starch thickening in the presence of moisture and heat. It is the total time consumed where a colloidal system from a temporary suspension turns to a permanent suspension.

Texturizing/Texturing agent: Texturing agent refers to additives that adds or modifies the overall texture or mouthfeel of food products.

Binding agent: Binding agent refers to food binders that are mixed in with other ingredients to help the food product to keep their shape and texture.

Water holding capacity (WHC): Water-holding capacity (or water-binding capacity, or water-absorption capacity) is a measure of the total amount of water that can be absorbed per gram of a powder/composition/ingredient.

Viscosity: Viscosity is the resistance of a fluid (e.g., liquid or gas) to a change in shape or movement of neighbouring portions relative to one another. Viscosity denotes opposition to flow.

Retrogradation: Retrogradation is a recrystallization process in which disaggregated amylose and amylopectin molecules in gelatinized starches reassociate to form ordered structures.

Stabilization: Stabilization refers to a process of making composition/food product physically more secure or stable.

Palatability: Palatability is the hedonic evaluation provided by foods or fluids that are agreeable to the “palate”, which often varies relative to the homeostatic satisfaction of nutritional, water, or energy needs.

pH: pH is a measure of the hydrogen ion concentration in solution and is also referred to as the degree of acidity or alkalinity.

Plant-derived: “Plant-derived” refers to ingredients extracted from a plant.

Flavorant/Flavor enhancer: Flavorant is a food additive that is used to improve the taste or smell of food products.

Nutraceuticals: Nutraceuticals are products derived from food sources that provide both nutrition and medicinal benefits.

Animal-based food products: Animal-based food products refers to food products derived from animals include meat and meat products, poultry products (meat and eggs), fish, shellfish, dairy products (milk and cheese).

Embodiments herein provide a plant-only composition for a food product. The plant-only composition comprises (i) about 1% to about 20% weight by weight of one or more legume starch sources, (ii) about 20% to about 60% weight by weight of one or more vegetable starch sources, (iii) about 5% to about 25% weight by weight of one or more cereal starch sources, and (iv) about 1% to about 20% weight by weight of one or more seed starch sources. The plant-only composition substitutes a starch ingredient in the food product.

In some embodiments, the plant-only composition comprises (i) about 5% to about 15% weight by weight of one or more legume starch sources, (ii) about 30% to about 50% weight by weight of one or more vegetable starch sources, (iii) about 10% to about 20% weight by weight of one or more cereal starch sources, and (iv) about 5% to about 15% weight by weight of one or more seed starch sources. The plant-only composition substitutes a starch ingredient in the food product.

In one aspect, a food product is provided. The food product comprising about 10% to about 15% weight by weight of a plant-only composition. The plant-only composition comprises (i) about 1% to about 20% weight by weight of one or more legume starch sources, (ii) about 20% to about 60% weight by weight of one or more vegetable starch sources, (iii) about 5% to about 25% weight by weight of one or more cereal starch sources, and (iv) about 1% to about 20% weight by weight of one or more seed starch sources. The plant-only composition substitutes a starch ingredient in the food product.

In another aspect, a plant-only modified starch replacement system for a food product comprising a plant-only composition is provided. The plant-only composition comprises (i) about 1% to about 20% weight by weight of one or more legume starch sources, (ii) about 20% to about 60% weight by weight of one or more vegetable starch sources, (iii) about 5% to about 25% weight by weight of one or more cereal starch sources, and (iv) about 1% to about 20% weight by weight of one or more seed starch sources. The plant-only composition substitutes a starch ingredient in the food product.

FIG. 1 illustrates a plant-only composition for a food product according to some embodiments herein. FIG. 1 depicts a table that includes ingredients 102 of the plant-only composition and weight 104 of the ingredients 102 of the plant-only composition. The plant-only composition comprises (i) about 1% to about 20% weight by weight of one or more legume starch sources, (ii) about 20% to about 60% weight by weight of one or more vegetable starch sources, (iii) about 5% to about 25% weight by weight of one or more cereal starch sources, and (iv) about 1% to about 20% weight by weight of one or more seed starch sources. The plant-only composition substitutes a starch ingredient in the food product.

In an embodiment, the physical characterization data associated with the ingredients of the plant-only composition comprises the protein, fiber, starch, sweetener, thickener, emulsifier-stabilizer system, and fat is stored in a database. A machine learning model determines a unique combination of ingredients based on the physical characterization data to prepare the plant-only composition. The machine learning model identifies plant-derived ingredient for starch replacements based on the parameters and ranges provided in Table 1 to give the list of ingredients for each possible functionality. The “Machine learning model” refers to computer software designed to recognize patterns or behaviors based on previous experience or data.

Based upon the known properties of ingredients in the database, the desired properties for the food product or formulation, and one or more plant-derived components or ingredients is determined to yield an effective formulation that can be used as a starch replacement component or ingredient or composition for food-based products and, in particular, plant-only food products for the plant-only food industry.

### Plant-Only Modified Starch Replacement System Food Product

Plant-only composition/modified starch replacement system agents used as additives in food products help the products maintain structure and texture by increasing water retention capacities, increasing pasting, improved resistance to retrogradation, and improved stabilization particularly during freezing and thawing cycles. Table 1 shows the percent by weight of the plant-only composition/modified starch replacement system of each of the preferred, essential plant-only categories and ingredients.

TABLE 1
The plant-only composition/modified starch replacement system

| | Preferred weight |
|---|---|
| Preferred, essential plant-only composition/ | percent of the |
| modified starch replacement system | plant-only |
| Categories/Ingredients | composition |
| 1. Legume starch source(s): any one or more of pea starch, | 5-15 |
| lupine starch, faba bean starch and protein, red lentils starch, | |
| lima bean, navy bean, mung bean, black gram flour, lentils | |
| flour, garbanzo bean, yellow pea flour and/or any substitutes | |
| imparting the same properties and functionalities | |
| 2. Vegetable starch source(s): any one or more of potato | 30-50 |
| starch, cassava starch, tapioca starch, mushroom flour, | |
| bamboo starch, sweet potatoes, beets starch, acorn squash | |
| starch, pumpkin starch, butternut squash, hubbard starch, | |
| and/or any substitutes imparting the same properties and | |
| functionalities | |
| 3. Cereal starch source(s): any one or more of sorghum | 10-20 |
| starch, maize (corn) starch, wheat starch, barley starch, pearl | |
| millet starch, ragi flour, finger millet starch, rice starch, oats | |
| starch, rye flour and/or any substitutes imparting the same | |
| properties and functionalities | |
| 3. Seed starch source(s): any one or more of quinoa starch, | 5-15 |
| amaranth starch, moringa seed flour, canary seed starch, | |
| chia seeds, poppy seeds flour, annatto seed flour, pistachio | |
| seed hull flour, sunflower seeds starch, date palm seeds | |
| starch and/or any substitutes imparting the same properties | |
| and functionalities | |

In Table 1 within each of the four categories, in some embodiments, the individual ingredients and combinations of two or more of them may be substituted for any of the others in that category. In some embodiments, for each category, a complete blend consisting of all of the named ingredients may be prepared for use in the modified starch replacement system.

In alternative embodiments for each of the categories of Table 1, it is expected that any of the individual ingredients listed may be replaced with one or more substitute ingredients that impart the same or similar properties and functionalities as each of the ingredients listed.

Further, although Table 1 provides a preferred, essential list of categories of ingredients with certain properties in the plant-only composition/modified starch replacement system, substitutions for these ingredients in the replacement system may be made in alternative embodiments for compliance with dietary requirements; without limitation, such as food sensitivities and food allergies. For example, in the protein category, if peanuts are selected as a desired protein source for a particular food product, peanut allergies in consumers would require finding a suitable alternative to develop a formulation free from peanuts so that an anaphylactic (allergic) reaction would not be triggered in the consumer with such allergies.

The plant-only composition/modified starch replacement system detailed in Table 1 as a component of a plant-only burger product or a Traditional Burger Product comprises generally between about 10 to about 15 percent of the total weight of the food product (e.g., Table 2), but may vary between as much as 1 percent to about 30 percent of the total weight, depending on the moisture content of the modified starch replacement system and that of the final food product (e.g., a plant-only burger product in any form).

TABLE 2
Various replacement systems' ingredients and combinations as components of plant-only burger products

| | Preferred Weight |
|---|---|
| | Percent of |
| | Plant-Only |
| Preferred, Essential, Plant-Only Food Product Replacement | Burger Product |
| Systems and/or Individual Ingredients and Combinations | (dry weight) |
| Protein sources (one or more of pea, mushroom, quinoa, | 10-20 |
| chickpeas) | |
| Methyl Cellulose (MC) replacement system ingredients | 5-10 |
| from five categories (proteins; fibers from whole grains, | |
| fruits, seeds and vegetables; starches; and vegetable | |
| binders) | |
| Plant-only composition/modified starch replacement | 10-15 |
| system ingredients from all four starch categories detailed in | |
| Table 1 (legume starch, vegetable starch, cereal starch and | |
| seed starches) within the ranges indicated for the | |
| replacement system | |
| Oils providing high levels of omega-3 fatty acids, MUFAs, & | 10-12 |
| MCTs (e.g., sunflower oil, coconut oil, flaxseed oil, rice | |
| bran oil, or other oil providing such fats at desired levels) | |
| Gums and Carrageenan replacement system (one or more | 10-15 |
| of quince seed, apple, mesquite, almonds) | |
| Shelf life extenders (one or more of garlic, black pepper, | 1-2 |
| oregano, bay laurel) | |
| Umami flavor (one or more of shitake and other | 0.5-2 |
| mushrooms, tomatoes, garlic, lotus stalk, onions, salt) | |
| Flavorant/flavor enhancer, nutraceutical (one or more of | 0.5-1 |
| cumin, coriander, paprika, black pepper) | |
| Flavor Enhancer (i.e., second flavor enhancer) (one or more | 1-2 |
| of nutritional yeast, cashews) | |
| Mineral Salts (Himalayan pink salt, sea salt, etc.) | 0.5-2 |
| Binding agents (one or more of chickpeas, oat fiber, | 5-10 |
| aquafaba, sugar beet pectin) | |
| Leavening agent replacement system ingredients from all | 0.5-1 |
| five categories (plant-only fibers; fruit pectin; fruit acids; | |
| plant-only starches; and cereal sources) within the ranges | |
| indicated for the replacement system (e.g., one or more of | |
| plum powder, apple cider vinegar, vegan buttermilk, and | |
| Leghemoglobin source(s) (one or more of beets, soy, red | 1-2 |
| radish) | |
| Lipid peroxidation inhibitors (one or more of black pepper, | 0.5-2 |
| bay | |

The plant-only composition/modified starch replacement system may comprise, as a percent by weight of the food product in which it is added, depending on the type of food product and whether water or other liquid is included as part of the food product, included but not limited to Traditional Burger Products and plant-only burger products, between about 0.05 to about 30 percent, between about 0.01 to about 0.10 percent, between about 0.10 to about 0.15 percent, between about 0.15 to about 0.20 percent, between about 0.20 to about 0.25 percent between about 0.25 to about 0.30 percent, between about 0.30 to about 0.35 percent, between about 0.35 to about 0.40 percent, between about 0.40 to about 0.45 percent, between about 0.45 to about 0.50 percent, between about 0.50 to about 0.65 percent, between about 0.65 to about 0.70 percent, between about 0.70 to about 0.75 percent, between about 0.75 to about 0.80 percent, between about 0.80 to about 0.85 percent, between about 0.85 to about 0.90 percent, between about 0.90 to about 0.95 percent, between about 0.95 to about 1.00 percent, between about 1.00 to about 1.05 percent, between about 1.05 to about 1.10 percent, between about 1.10 to about 1.15 percent, between about 1.15 to about 1.25 percent, between about 1.25 to about 1.35 percent, between about 1.35 to about 1.50 percent, between about 1.50 to about 1.75 percent, between about 1.75 to about 2.00 percent, between about 2 to about 2.25 percent, between about 2.25 to about 2.50 percent, between about 2.50 to about 2.75 percent, between about 2.75 to about 3 percent, between about 3.00 to about 3.25 percent, between about 3.25 to about 3.5 percent, between about 3.5 to about 4.5 percent, between about 4.5 to about 5.5 percent, between about 5.5 to about 6.5 percent, between about 6.5 to about 7.5 percent, between about 7.5 to about 8.5 percent, between about 8.5 to about 9.5 percent, between about 9.5 to about 10 percent, between about 10 to about 13 percent, between about 13 to about 16 percent, between about 16 to about 20 percent, between about 20 and about 25 percent, and between about 25 and about 30 percent.

### Categories of Ingredients Among the Preferred, Essential Categories of Ingredients in the Modified Starch Replacement System

A principal ingredient category in the plant-only composition/modified starch replacement system for plant-only burger products in particular is one or more plant-only legume starch sources such as pea starch, faba bean starch or lupine starch.

Category 1: legume starch source(s): Pea starch is one example of a legume starch that can be used as part of the modified starch replacement system in food products. Alternative sources include faba bean starch and lupin starch, each of which, in this plant-only composition/modified starch replacement system designed by the Charaka machine learning system, may be interchanged with the others or may be used in combination of two or more of these ingredients, or with (or substituted by) other ingredients known to a person of ordinary skill that would provide the same or similar characteristics and features (functionality and properties) for this category in the composition/system. Further detail on this category is found in Table 10.

Pea starch: Peas comprise almost 40 percent starch, which has a neutral color and taste making it an ideal modified starch replacer ingredient in a food product. Pea starch resists breakdown in high temperatures, and its high amylose content contributes to water retention properties, making it an ideal modified starch substituted as a thickener, emulsifier, and gelling agent in food products. In some embodiments, pea starch is provided in the modified starch replacement system as a finely ground powder. In other embodiments, it may be mixed with water plant-derived liquid or other liquid to form a liquid, gel or other alternative form the system suitable for mixing and storing, freezing and/or drying. Pea starches promote the ayurvedic properties of Virya (cold) Vipaka (sweet), Ruksa (dry in nature) and Laghu (light to digest).

In the disclosed embodiments, the amount of legume starch (from one or more of faba beans, peas, lupine, red lentils, lima bean, navy bean, mung bean, black gram flour, lentils flour, garbanzo bean, yellow pea flour and/or one or more substitutes that have the same or similar properties and functionalities as these ingredients) as a percentage of the plant-only composition/modified starch replacement system weight ranges between about 1 to about 20 percent, between about 1 to about 5 percent, between about 2 to about 7 percent, between about 5 to about 10 percent, between about 5 to about 15 percent, between about 8 to about 13 percent, between about 10 and about 20 percent, between about 14 to about 19 percent, between about 15 to about 20 percent, and between about 17 to about 20 percent.

In some embodiments, the legume starch source has a pH of about 5 to 8, a peak viscosity of about 1107 to about 2173 Centipoise (cP), a water holding capacity of about 1.81 to about 2.63 gallons water per gram (g water/g), an amylose content of about 30.61% to about 33.55%, a swelling power of about 1.05 to about 21 g/g depending on the temperature, a moisture content of about 15%, a granule size of about 2 to about 40 micrometres (m), a crystallinity of about 18.9% to about 36.5%, and a gelatinization/pasting temperature of about 60° C. to about 80° C.

In some embodiment, the legume starch is restricted-swelling starch, especially chemically cross-bonded products. Cross-linkages within the granule markedly reduce swelling and solubilization, and stabilize the swollen granule against mechanical fragmentation. Hence, the Brabender curve of legume starch shows no pasting peak, but rather a very high viscosity which remains constant or else increases during cooking.

Category 2: Vegetable starch source(s): Potatoes, cassava, tapioca, mushroom, bamboo, sweet potatoes, beets, acorn squash, pumpkin, butternut squash, and hubbard are examples of vegetables containing a high amount of starch making them ideal replacements for the modified starches added to commercially available food products. Each of these may be interchanged for each other, or they may be used in combination, or with other, appropriate substitutes known to a person of ordinary skill that would provide the same characteristics and features (properties, functionalities) as other ingredients in this category of the composition/system. Further detail on this category is found in Table 10.

Potato starch has a clear color, it is a good gelling agent, and has a slightly lower amylose content (22%, versus 25%) in cornstarch. Unlike cornstarch and other vegetable starches, however, potato starch has a significantly larger granule size. When potato starch is heated beyond a temperature required for gelatinization, the large granules swell to many times their original size, then collapse and release amylose in a continuous medium. Among starches that contribute to the textural properties of imitation meat products including those in Traditional Burger Products and plant-only burger products, potato starch gels at a lower temperature, and when it cools the resulting sauce is a viscous, translucent mixture that flows, rather than a brittle gel. In most embodiments, potato starch is provided in the plant-only composition/modified starch replacement system as a finely ground powder. In other embodiments, it is mixed with water, plant-derived liquid or other liquid, and is provided in a liquid, gel or other moist alternative form of the system suitable for mixing and storing, freezing and/or drying. Potato starch promotes the ayurvedic properties of Rasa: Madhura (Sweet), Kashya (Astringent) Guna: Guru (Heavy) and Viraya: Hima (Cool).

In the disclosed embodiments the amount of vegetable starch source(s) (one or more of potato starch, cassava starch, tapioca starch, mushroom flour, bamboo starch, sweet potatoes, beets starch, acorn squash starch, pumpkin starch, butternut squash, hubbard starch or substitute with the same or similar properties and functionalities) as a percent of the plant-only composition/modified starch replacement system weight, ranges from between about 20 to about 60 percent, between about 20 to about 30 percent, between about 30 to about 40 percent, between about 30 to about 50 percent, between about 40 to about 50 percent, and between about 50 to about 60 percent.

In some embodiments, the vegetable starch source has a pH of about 6 to 8, a bulk density of about 700 kilogram/cubic meter (kg/cc), a moisture content of about 20%, a peak viscosity of about 0.1 to about 0.9 pascal seconds at a shear rate of 115 inverse second (s⁻¹), a water holding capacity of about 415.13% to about 595.26%, an amylose content of about 15% to about 30%, a swelling power of about 20.76% to about 26.92%, a crystallinity ranging from about 20.33% to about 22.25%, and a gelatinization/pasting temperature of about 68.6° C. to about 69.3° C.

In some embodiments, the vegetable starch is high-swelling starch and the granules of the vegetable starch swell enormously when cooked in water, and the internal bonding forces become tenuous and fragile toward shear. Hence, the Brabender curve shows a high pasting peak followed by rapid and major thinning during cooking.

Category 3: cereal starch source(s): Sorghum, wheat, barley, pearl millet, ragi, finger millet, rice, oats, rye and maize (corn) are excellent cereal sources of starches that can be used as part of the plant-only composition/modified starch replacement system in food products. Each may be interchanged with the other or they may be used in combination or with (or substituted by) other ingredients—alternatives—known to a person of ordinary skill that would provide the same characteristics and features (properties, functionalities) for this category in the composition/system. Further detail on this category is found in Table 10.

Sorghum is an ancient and high-antioxidant containing, gluten-free cereal grain. More than 25 percent of the weight of sorghum starch is due to high amylose content. The amylose/amylopectin ratio of 0.35 makes it a suitable replacement for modified starches as a thickener and gelling agent in food products. In some embodiments, sorghum starch is provided in the composition/system as a finely ground powder. In other embodiments, it may be mixed with water, plant-derived liquid or other liquid to create a liquid, gel or other moist alternative form of the composition/system suitable for mixing and storing, freezing and/or drying. Sorghum starch promotes the ayurvedic properties of Rasa: Madhura (Sweet), Kashya (Astringent), Guna: Laghu (Easy to digest), Virya: Hima (Cold), and Vipaka: Madhura (Sweet).

In the disclosed embodiments, the amount of starch from cereals like sorghum or its alternatives or substitutes with the same or similar properties and functionalities, as a percent of the modified starch replacement system weight, ranges from between about 5 to about 25 percent, between about 5 to about 10 percent, weight between about 10 to about 20 percent, between about 7 to about 12 percent, between about 12 to about 17 percent, between about 17 to about 22 percent, and between about 22 to about 25 percent.

In some embodiments, the cereal starch source has a swelling power of about 3.3 to about 8.8 g/g, a bulk density of about 513.30 to about 585.10 grams per litre (g/l), a peak viscosity of about 1296 to about 3348 Centipoise (cP), a water holding capacity of about 2.42 to about 3.35 gallons water per gram (g water/g), an amylose content of about 14% to about 30%, a gelatinization/pasting temperature of about 68° C. to about 72° C., and a gelatinization time of about 16.59 minutes to about 19 minutes.

In some embodiments, the cereal starch are moderate-swelling starches as their granules do not swell excessively to become fragile, and the cereal starch shows a lower pasting peak and much less thinning during cooking.

Category 4: Seed starch source(s): Quinoa flour milled from the seed, quinoa, is a good source of starch that can be used as part of the plant-only composition/modified starch replacement system in food products. Quinoa also is an excellent source of antioxidants, proteins, and unsaturated fatty acids. Quinoa starch is soluble, it retains water, and it gels, foams and emulsifies. Its solubility is due to the hydrophilic-hydrophobic balance of proteins and the quality of its interactions with water and other solvents. An alternative source of starch within this fourth category includes amaranth starch, moringa seed flour, canary seed, chia seeds, poppy seeds, annatto seed flour, pistachio seed hull flour, sunflower seeds starch, date palm seeds starch and each may be interchanged with the other or they may be used in combination or with (or substituted by) other ingredients known to a person of ordinary skill that would provide the same characteristics and features (properties and functionalities) for this category in the composition/system. Further detail on this category is found in Table 10.

Quinoa starch: In some embodiments, quinoa starch is provided in the composition/system as a finely ground powder. In other embodiments, it may be combined with water, plant-derived liquid or other liquid to create a liquid, gel or other moist form of the composition/system suitable for mixing and storing, freezing and/or drying. Quinoa flour promotes the ayurvedic properties of Rasa: Madhura (Sweet), Guna: Laghu (Light, easy to digest), Virya: Hima (Cool) as shown in table 3.

In the disclosed embodiments, seed starch source(s) (one or more of quinoa, amaranth, moringa seed, canary seed, chia seeds, poppy seeds, annatto seed, pistachio seed, sunflower seeds, date palm seeds and/or one or more substitutes that have the same or similar properties and functionalities as these ingredients) as a percentage of the modified starch replacement system weight ranges between about 1 to about 20 percent, between about 1 to about 5 percent, between about 2 to about 7 percent, between about 5 to about 10 percent, between about 5 to about 15 percent, between about 8 to about 13 percent, between about 10 and about 20 percent, between about 14 to about 19 percent, between about 15 to about 20 percent, and between about 17 to about 20 percent.

In some embodiments, the seed starch source has a swelling power of about 2.05 to about 4.85 g/g, a water holding capacity of about 1.81 to about 2.63 gallons water per gram (g water/g), an amylose content of about 16% to about 30.8%, a gelatinization/pasting temperature of about 54° C. to about 71° C., a bulk density of about 738 to about 842 kilograms per meter cube (kg/m³), a hardness value of about 20.8 grams, a moisture content of about 4.6% to about 25.8%, and a peak viscosity of about 1000 to about 2400 Centipoise (cP). In some embodiments, the seed starch has restricted swelling similar to legume starch.

One or more ingredients from each of the four modified starch replacement categories of Table 1 combined into a plant-only composition/replacement system: legume starches (pasting, texturizer and gelling), vegetable starches (lower gelatinization temperature, water retention), cereal starches (gelatinization, thickener, texturizer), and seed starches (texturizer, freeze-thaw stability, viscosity), along with their Ayurvedic properties (as shown in Table 3), results in a plant-only composition/modified starch replacement system that may be use in whole or part in any variety of food products. The primary example provided among the disclosed embodiments is the plant-only composition/replacement system's use in Traditional Burger Products and other, plant-only burger products. Alone or in combination as a plant-only composition/modified starch replacement system, the previously described ingredient categories are effective and natural components in the plant-only composition/modified starch replacement system for burger products, baked products or other food product categories in an amount of about 0.5 percent to up to 30 percent or more by weight of the food product, depending on the type of food product, the amount of liquid added to the composition/system (if any), and the replacement ingredients needed or desired for a particular application. Table 2 above shows preferred ranges percentages as a function of a plant-only burger product weight for the modified starch replacement system, as well as for other replacement systems and categories of other replacement ingredient combinations.

### Preparation of the Plant-Only Composition/Modified Starch Replacement System or its Component Categories

In one embodiment, the plant-only composition/modified starch replacement system, or any of its individual categories, individual ingredients or combinations of ingredients within each category, can be prepared by combining and mixing the dried, powdered ingredients selected from Table 1 in the relative amounts identified as preferred, essential ingredients of the system to be used in a desired food product. In some embodiments, the plant-only composition/modified starch replacement system may be in the form of a liquid or gel due to the addition of water or other plant-derived liquid to one or more of the ingredients or categories of ingredients before mixing, such as, for example, aquafaba in liquid form. In some embodiments, the plant-only composition/modified starch replacement system is mixed with additional water or plant-derived liquid, then dried and powdered and stored. In some embodiments the plant-only composition/modified starch replacement system is prepared in liquid form and freeze dried.

In certain embodiments, the plant-only composition/modified starch replacement system may be prepared and stored as a liquid or moist form (as in a gel or dough). In certain other embodiments, the modified starch replacement system may be prepared as a liquid, gel or in dried form and then frozen for storage. In other embodiments, each of the categories of ingredients, individual ingredients, or combinations of ingredients within each of the categories of the plant-only composition/modified starch replacement system, whether in liquid, gel, dried or other form, are mixed individually directly into and become a part of another food product rather than being combined as the complete replacement system/composition prior to incorporation into another food product.

In some embodiments, the plant-only composition/modified starch replacement system stands alone as a plant-only food product. In other embodiments, the plant-only modified starch replacement system is a component of another food product, such as a plant-only burger product, (i.e., including imitation meat products). In certain embodiments, the plant-only modified starch replacement system is a component of a baked good food product, chocolate, fried food products, frozen ice cream or frozen imitation dairy product, or frozen burger or burger mix, each of which may then be incorporated into other food products. In still other embodiments, the food product is one of several components used to create final food product. In other embodiments, the food product is a Traditional Burger Product. In some embodiments, the ingredients of Table 1 may be selected and combined in other relative amounts (a variety of ranges) identified for each of the four plant-only composition/modified starch replacement system categories discussed infra to achieve the required functional characteristics most closely resembling those of modified starch in a variety of food products, including, e.g., Traditional Burger Products and plant-only burger products.

The combination of categories and ingredients comprising a modified starch replacement system for traditional ingredients and additives in commercially available animal-based and plant-based products, as well as their physicochemical and Ayurvedic properties are shown in Table 3.

TABLE 3
Plant-only modified starch replacement system categories of ingredients and their properties

| | | Compounds | | |
|---|---|---|---|---|
| Plant-Only | | responsible | | |
| Category/ | | for the | Physicochemical | Ayurvedic |
| Ingredient | Functionality | functionality | Properties | Properties |
| Legume | Pasting: | Amylose | Moisture: Max 15.0% | Vipaka: |
| starch | formation of | (30.61 to | pH: 5.0 to 8.0 | sweet |
| source(s) | high viscosity | 33.55%) and | Peak Viscosity: | Ruksa: dry |
| (one or more | solution when | amylopectin | about 1107 to about | in nature |
| of pea starch, | heated in | | 2173 Centipoise (cP) | Virya: Cold |
| lupine starch, | water. | | The granule size of | Laghu: |
| faba bean | Gelling | | normal, smooth pea | Light to |
| starch, red | capacity: | | starch is variable: | digest |
| lentils starch, | Legume starch | | 2-40 μm. Crystallinity | |
| lima bean, | is available | | 18.9-36.5% | |
| navy bean, | mainly as a by- | | Gelatinization/ | |
| mung bean, | product of | | Pasting | |
| black gram | protein | | temperature: 60-80° | |
| flour, lentils | extraction, and | | Celsius | |
| flour, | is thus a | | WHC (water | |
| garbanzo | relatively | | holding capacity): | |
| bean, yellow | inexpensive | | 1.81-2.63 g water/g | |
| pea flour | starch versus | | Amylose content: | |
| and/or | corn (maize), | | 30.61%-33.55% | |
| substitute(s) | wheat, and | | Swelling power: | |
| exhibiting the | potato | | 1.05 to 21 g/g | |
| same | starches. | | (range is temperature | |
| properties | | | dependent, upper | |
| and | | | limit is taken at 100 C.) | |
| functionalities | | | | |
| etc.). | | | | |
| Vegetable | When heated | Content is | Moisture content: | Rasa: |
| starch | beyond | 70-80% | Max 20% | Madhura |
| source(s) | gelatinization | amylopectin | pH: 6 to 8 | (Sweet), |
| (one or more | temperatures, | | Bulk density: 700 kg/cc, | Kashya |
| of potato | granules swell | | Crystallinity | (Astringent) |
| starch, | to many times | | ranging from | Guna: Guru |
| tapioca | their original | | 20.33% to 22.25% | (Heavy) |
| starch, | size, then | | Lower | Viraya: |
| cassava | collapse and | | gelatinization/ | Hima (Cool |
| starch, | release | | Pasting | |
| mushroom | amylose in a | | temperature vs. | |
| flour, | continuous | | other starches: | |
| bamboo | medium. | | 68.6-69.3°° C. | |
| starch, sweet | Gelatinization | | Peak viscosity: 0.1 | |
| potatoes, | takes place at | | and 0.9 Pa · s, at a | |
| beets starch, | lower | | shear rate of 115 s − 1 | |
| acorn squash | temperatures | | WHC: | |
| starch, | versus in other | | 415.13-595.26% | |
| pumpkin | starches | | Amylose content: | |
| starch, | contributing to | | 15-30% | |
| butternut | the textural | | Swelling power: | |
| squash, | properties in | | 20.76-26.92% | |
| hubbard | plant-and | | | |
| starch, and/or | meat- | | | |
| substitute(s) | containing | | | |
| exhibiting the | food products. | | | |
| same or | | | | |
| similar | | | | |
| properties | | | | |
| and | | | | |
| functionalities | | | | |
| etc.). | | | | |
| Cereal starch | Gelatinization | Sorghum | Swelling power: 3.3 | Rasa: |
| source(s). | of starch | starch | to 8.8 g/g | Madhura |
| (one or more | occurs while | consists | Gelatinization/Pasting | (Sweet) |
| of sorghum | heading due to | mainly of | temperature: | Kashya |
| starch and | breaking of | amylopectin | 68° C. to 72° C. | (Astringent) |
| maize (corn) | hydrogen | and amylose. | Bulk density: | Guna: |
| starch, wheat | bonds within | | 514.35 ± 0.95- | Laghu |
| starch, barley | the starch | | 584.10 ± 1.00 g/L | (Easy to |
| starch, pearl | granules; | | Gelatinization time: | digest) |
| millet starch, | resulting in | | 16.00 ± 0.01- | Virya: |
| ragi flour, | rearrangement | | 18.00 ± 1.00 mins; | Hima |
| finger millet | of molecules. | | Peak viscosity: | (Cold) |
| starch, rice | This promotes | | 1296-3348 cP or more | Vipaka: |
| starch, oats | water uptake, | | WHC: | Madhura |
| starch, rye | granular | | 2.42-3.35 g/g | (Sweet) |
| flour and/or | swelling, and | | Amylose content: | |
| substitute(s) | an increase in | | 14-30% | |
| imparting the | viscosity. | | | |
| same or | Water enters | | | |
| similar | the amorphous | | | |
| properties | regions of the | | | |
| and | granules with | | | |
| functionalities | heat; these | | | |
| etc.). | regions expand | | | |
| | and transmit | | | |
| | disruptive | | | |
| | forces into the | | | |
| | crystalline | | | |
| | regions, | | | |
| | leading to | | | |
| | swelling of the | | | |
| | granules, | | | |
| | increased | | | |
| | viscosity, and | | | |
| | thickening and | | | |
| | texturizing of | | | |
| | the food | | | |
| | product. | | | |
| Seed starch | Small | Quinoa | Moisture: 10.51% in | Rasa: |
| source(s) | granules; can | starch: low | starch | Madhura |
| (one or more | be used to | amylose | Hardness values of | (Sweet) |
| of quinoa | replace | content and | gel: 20.8 g | Guna: |
| starch, | modified | unique | bulk density: 790 ± 52 | Laghu |
| amaranth | starches to | amylopectin | kg/m3 | (Light, easy |
| starch, | produce a | structure | Moisture content: | to digest) |
| moringa seed | creamy, | influence the | 4.6 to 25.8% | Virya: |
| flour, canary | smooth | functional | Swelling power: | Hima |
| seed starch, | texture. | properties. | 2.05-4.85 g/g | (Cool) |
| chia seeds, | Amylose | | (constant swelling | |
| poppy seeds | content is | | power and shows no | |
| flour, annatto | significantly | | increase in swelling | |
| seed flour, | lower | | power at | |
| pistachio | (9.43~10.90%) | | temperatures higher | |
| seed hull | than other | | than 75° C.) | |
| flour, | starches. | | Viscosity: The | |
| sunflower | Amylopectin | | quinoa starch | |
| seeds starch, | content is high, | | developed a higher | |
| date palm | contributing | | and significantly | |
| seeds starch | good | | different (P < 0.05) | |
| and/or | resistance to | | viscocity | |
| substitute(s) | retrogradation. | | Peak viscosity: | |
| exhibiting the | Excellent | | 1000-2400 cP | |
| same or | freeze- thaw | | Gelatinization/Pasting | |
| similar | stability; good | | Temperature: | |
| properties | for use in | | 54° C. to 71° C. | |
| and | frozen food | | WHC: | |
| functionalities | products. | | 1.81-2.63 g water/g | |
| etc.). | | | Amylose content: | |
| | | | 16-30.8% or more | |

In some embodiments, the gelatinization occurs when starch is heated in the presence of water, resulting in an expansion due to hydration. The starch granules rupture resulting in the breakdown of hydrogen bonds. When the gelatinized granules are continually heated, amylose leaches out of the granules resulting in a paste.

The temperature, when the viscosity of the starch begins to rise, is recorded as the pasting temperature (PT). Since the viscosity only begins to increase once the starch granules are completely gelatinized, the pasting temperature is usually higher than the gelatinization temperature. Pasting thus takes place immediately after gelatinization, and it refers to changes in viscosity before, during and after the gelatinization process. The pasting temperature thus provides an indication of the minimum temperature required to cook a flour.

TABLE 4
Gelatinization range for various legume starch sources.

| Starch | Gelatinization range, ° C. |
|---|---|
| Lima bean | 72-76-81.5 |
| | 70-75-85 |
| Lentil | 65-68.5-71.5 |
| | 64-69-74 |
| Yellow pea | 64-67.5-73 |
| | 63-67-73.5 |
| Navy bean | 67-69.5-73.5 |
| | 66-70-77 |
| Garbanzo | 66-69.5-72 |
| | 62.5-65-68 |
| Mung bean | 64-69-76 |
| U.S. | 65.5-70-76 |
| U.S. | 66-70-74 |
| Hong Kong | 66.5-70-74 |
| Philippine | 60.5-66-78 |
| Yamamura | |
| Wrinkled pea | . . . |
| | 69-83 |

The reference link for the Table 4 is as follows: https://www.cerealsgrains.org/publications/cc/backissues/1968/Documents/chem45_564.pdf.

In some embodiments, the swelling power/Hydration takes place where water moves into the interior of the starch and also binds to other components such as protein. At temperatures below 50° C., swelling of starch granules is minimal, but at higher temperatures aggressive swelling is found and breakdown of granules can also start to occur.

TABLE 5
Swelling power and solubility of starches isolated
from various legume starch sources.

| | | Temperature (° C.) | | | | |
|---|---|---|---|---|---|---|
| Properties | Varieties | 50 | 60 | 70 | 80 | 90 |
| Swelling | Red | 0.81 ± | 0.91 ± | 3.56 ± | 6.87 ± | 10.40 ± |
| power | Adzuki | 0.18 cd | 0.29 c | 0.23 d | 0.50 c | 0.06 d |
| (g/g) | Baiyue | 3.38 ± | 3.66 ± | 4.58 ± | 6.84 ± | 11.26 ± |
| | | 0.12 a | 0.05 a | 0.1 c | 0.28 c | 0.29 c |
| | Faba | 1.09 ± | 1.13 ± | 6.85 ± | 10.29 ± | 12.67 ± |
| | Bean | 0.05b | 0.19 c | 0.15b | 0.36 b | 0.02 b |
| | Chick | 1.78 ± | 1.81 ± | 10.60 ± | 16.32 ± | 18.25 ± |
| | pea | 0.20d | 0.03 | 0.12 | 0.25 | 0.06 |

The reference link for the Table 5 is as follows: https://onlinelibrary.wiley.com/doi/full/10.1002/fsn3.865.

In some embodiments, the water holding capacity (WHC) is a measure of hydration capacity, and the determination is a weight measure of swollen starch granules and their occluded water. Food eating quality is often connected with retention of water in the swollen starch granules. In some embodiments, amylose content provides gel strength and the amylopectin provides high viscosity. For example, the amylose content for tapioca is ˜17%, and amylopectin is 82%.

In some embodiments, the peak viscosity is an indicator of starch granule swelling and high-value peak viscosity indicates a high capacity of swelling of starch. Starches with high peak viscosity are possible to show high breakdown values, leading to weak gels. Hence, it has to be in a medium range.

TABLE 6
Conversion factor used for viscosity is as follows:
RVA (rapid viscosity analyzer) final viscosity

| RVU (Rapid-Visco | Centipoise |
|---|---|
| Analyser unit) | (cP) |
| ≥120 | >1440 |
| ≥50 & <120 | ≥600 & <1440 |
| <0 | <600 |

The reference link for the Table 6 is as follows: https://www.grainscanada.gc.ca/en/grain-research/scientific-reports/rva/?wbdisable=true

Table 7 below provides an overview of the typical formulation of a commercially available, meat-based burger, including preservatives and other chemical additives.

TABLE 7
Typical formulation for commercially available meat-based burgers

| | Weight | |
|---|---|---|
| | percent | |
| Meat-based | of burger | |
| Ingredient/category | (%) | Function |
| Beef/Pork | 60-70 | Meat-based protein and fat source |
| Water | 10 | Moisture |
| Beef Fat | 15-20 | Animal fat source |
| Soy Protein | 10-15 | Protein source |
| Salt | 10-15 | Flavor |
| Caramel color | 55-15 | Colorant |
| Sodium | 2-4 | Stabilizer, meat curer |
| polyphosphates | | |
| Maltodextrin | 0.25-0.75 | Fat replacer, shelf life extender |
| Cochineal carmine | 5-15 | Colorant |
| Monosodium | 0.1-0.8 | Flavoring agent |
| glutamate | | |
| Onion | 5-10 | Preservative, flavor enhancer |
| Garlic | 5-10 | Preservative, flavor enhancer |
| Cumin | 1-5 | Preservative, flavor enhancer |
| Sodium erythorbate | 0.5-0.7 | Cure accelerator |
| Natural beef/pork | 1-2 | Flavor |
| flavors | | |
| Sodium citrate | 2-3 | Acidity regulator |
| Disodium inosinate | 0.1-0.3 | Flavor enhancer |
| Sodium guanylate | 0.1-0.3 | Flavor enhancer |
| Black pepper | 1-5 | Flavor enhancer |
| Capsicum | 1-5 | Flavor enhancer |
| Soybean | 10-40 | Textured vegetable protein |
| Nisin | 0.01-0.05 | Preservative |
| Nitrites and Nitrates | 1-5 | Taste, colorant, antimicrobial |
| Phosphate Salts | 0.1-0.5 | Moisture retention, stabilizer, |
| | | shrinkage reducer, flavor enhancer, |
| | | colorant |
| Tertiary | 0.02-0.03 | Antioxidant |
| utylhydroquinone | | |
| (TBHQ) | | |

In some embodiments, the plant-only composition/modified starch replacement system when added to meat-based products within the Traditional Burger Products such as in the example above, replaces some or all of the soy and meat proteins/fat and the maltodextrin.

Table 8 below, similarly provides an overview of the typical formulation of a commercially available, plant-based burger or burger mix, with numerous chemical additives. Although a somewhat improved profile compared to the profile of the formulation of the meat-based burger shown in Table 7, it can be improved for certain consumer diets with the use of plant-only replacements such as the plant-only composition/modified starch replacement system. The plant-only composition/modified starch replacement system may also be used to improve the quality of meat-based food products intended for pets and other animals.

TABLE 8
Typical formulation for commercially available, plant-based burgers

| | Weight | |
|---|---|---|
| | Percent | |
| Plant-based Burger | of Product | |
| Ingredient/Category | (%) | Function |
| Pea protein isolate | 70-80 | Protein source |
| Water | Variable | Moisture |
| Expeller-pressed canola | 2-5 | Fat source |
| oil | | |
| Refined coconut oil | 20-25 | Fat source |
| Cellulose from bamboo | <2 | Texturizer |
| Methylcellulose | 0.1-2 | Thickener, emulsifier |
| Potato starch | 2.4 | Thickener |
| Flavoring agents | 10-15 | Flavor |
| Maltodextrin | 0.2-0.9 | Fat replacer, shelf life extender |
| Yeast extract | 1-2 | Flavor enhancer |
| Salt | 2-5 | Flavor |
| Sunflower oil | 8-10 | Fat source |
| Vegetable glycerin | 5-15 | Sweetener |
| Dried yeast | 1-3 | Flavoring agent |
| Gum arabic, konjac | 0.1-1 | Emulsifier, stabilizer, thickener, |
| gum, xanthan gum, | | foaming agent, texturizer, |
| Locust bean gum, | | moisture retention. |
| carrageenan | | |
| Citrus extract | 1-3 | Antimicrobial, preservative |
| (to protect quality) | | |
| Ascorbic acid | 0.1-1 | Color retention |
| (to maintain color) | | |
| Beet juice extract | 5-10 | Colorant |
| (for color) | | |
| Acetic acid | 0.5-2 | Shelf life extender |
| Succinic acid | 1-2 | Acidulant/flavoring agent |
| Modified food starch | 5-15 | Texturizer |
| Annatto (for color) | 2-5 | Colorant |

In some embodiments, the plant-only composition/modified starch replacement system when added to plant-based products within the Traditional Burger Products such as in the example above, replaces some or all of the oils, cellulose, potato starch, pea protein and various gums.

Table 9 below provides a comparison of the commercial plant-based versus currently disclosed, plant-only formulations burger products with a variety of replacement systems.

TABLE 9
Comparison of formulations of plant-based burgers and burger mixes versus
commercially available plant-only burgers and burger mixes, indicating relevant
replacements for traditional additives in plant-based burger

| Example Formulation of Commercially | Plant-only Composition/Formulation for |
|---|---|
| Available Plant-based Burger Products | Burger Products |
| with Traditional Additives, Including | Replacing Commercially Available |
| Modified Starches | Modified Starches |
| Pea protein isolate | One or more protein source(s) (peas, |
| | lupine, mushrooms, quinoa, chickpea, etc.) |
| Water | Water (from plant or external source) |
| Expeller-pressed canola oil | One or more oils (sunflower, coconut, |
| Refined coconut oil | flaxseed and rice bran) containing high |
| Sunflower oil | levels of MUFAs, omega-3 fatty acids, & |
| | MCTs |
| Cellulose from bamboo | Plant-only methyl cellulose (MC) |
| Methylcellulose | replacement system (blend of five |
| | categories of ingredients: protein, fibers |
| | from whole grains; fibers from fruits, seeds |
| | and vegetables, vegetable binding agents |
| | and starches) (0.5-30% weight of the plant- |
| | only burger product, depending on whether |
| | water or other liquid is included in the |
| | burger product or other mix). |
| Annatto (for color) | Plant-only flavorants, nutraceuticals (one |
| Natural flavor | or more of cumin, coriander, paprika, black |
| | pepper, etc.) Plant-only umami flavor |
| | replacement system (one or more of |
| | shiitake and other mushrooms, tomatoes, |
| | garlic, lotus stalk, onions, mineral salts, |
| | etc.) |
| Maltodextrin | Plant-only shelf life extender (one or more |
| Yeast extract | of garlic, black pepper, oregano, bay leaf etc.) |
| Vegetable glycerin | Flavor enhancer (one or more of nutritional |
| Dried Yeast | yeast, cashews etc.) Plant-only leavening |
| | agent replacement system (combination of |
| | ingredients from five categories, including |
| | one or more of psyllium husk, apple |
| | nomace rice starch faha heans nlum |
| Salt | Mineral Salts (Himalayan pink salt, sea salt) |
| Gum arabic, konjac gum, xanthan gum, | Plant-only gums and carrageenan |
| locust bean gum, carrageenan | replacement system (one or more of quince |
| | seed, apple, mesquite, almond, etc.) |
| Citrus extract (to protect quality) | Plant-only leghemoglobin (one or more of |
| Ascorbic acid (to maintain color) | beets, red radish, etc.) |
| Beet juice extract (for color) | |
| Acetic acid | Plant -only shelf life extender (one or more |
| | of garlic, black pepper, onion etc.) |
| Succinic acid | Plant-only flavor enhancer (one or more of |
| | paprika, black pepper, beet juice, etc.) |
| Modified food starch | Plant-only composition/modified starches |
| Potato starch | replacement (combination of ingredients |
| | from four categories of plant-only modified |
| | starch sources referenced in Table 1: |
| | legumes, vegetables, cereals and seeds) |

Table 10 below provides a detailed description of the functionality of the various plant-only composition/modified starch replacement systems and other categories of ingredients specific to plant-only burger products, as determined by the Charaka machine learning system described above.

### Functionality of Replacement Systems for Burger Products:

The unique combination of essential ingredients in each plant-only replacement system, including individual ingredients or combinations of ingredients within each category of the system provides certain functionalities necessary for quality, plant-only burger products, as shown in the following table.

TABLE 10
Functionalities Provided by Plant-Only Composition/Replacements in Burger Products

| | Plant-only | Plant-Only Ingredients, Ingredient |
|---|---|---|
| | Burger Product | Combinations or Plant-Only |
| | Essential | Composition/Replacement Systems |
| | Ingredients and | Enabling Functionality within the Burger |
| Function | Combinations | Product Composition |
| Emulsifier | One or more oils | Sunflower oil is primarily (85%) unsaturated fatty |
| | providing high | acids comprising 14-43% oleic acid and 44-75% |
| | levels of | linoleic acid, the latter, which results in the oil's |
| | MUFAs, | lower freezing point, and contributes to the lower |
| | omega 3 fatty | freezing points of products in which sunflower oil |
| | acids, & MCTs | is added. |
| | (sunflower oil, | Coconut oil, in contrast, is~87% saturated fatty |
| | coconut oil, | acids, lauric acid accounting for~49% of the |
| | flaxseed oil, rice | saturated fats. Other saturated fatty acids include |
| | bran oil, or other | myristic, palmitic, stearic, oleic, capric and caprylic |
| | oil substitute | acids. |
| | exhibiting the | Flaxseed comprises~35-45% oil and 20-30% |
| | same or similar | protein. The oily portion consists of 9-10% |
| | properties and | saturated fatty acids (palmitic and stearic), ~20% |
| | functionalities) | monounsaturated fatty acids (mainly oleic acid), |
| | | and more than 70% alpha-linolenic fatty acids. |
| Thickening | Thickeners and | Chickpea fractions (starch, proteins) function as |
| agents/ | binding agents | binders and are also a protein source (72-85% are |
| binding | (one or more of | globulins and albumin. Protein matrices formed |
| agent | chickpeas, oat | have the ability to hold water and fat. Their binding |
| | fiber, passion | properties are also attributable to water soluble and |
| | fruit, aquafaba, | insoluble carbohydrates: cellulose, starch and |
| | sugar beet | hemicellulose. Soluble carbohydrates |
| | pectin, and | have higher water binding capacities, and water |
| | substitutes with | soluble- and insoluble polysaccharides also absorb |
| | the same or | oil. |
| | similar | Oat fiber retains water, decreases cooking losses |
| | functionalities | and has neutral flavor. Oats have a fiber type of P- |
| | and properties) | glucan, a soluble fiber accounting to 4%. It depicts |
| | | functional properties as a potential binding agent. |
| | | Oat fiber provides the flavor, texture and mouthfeel |
| | | of fat. |
| | | Passion fruit has a high proportion (52%) of |
| | | insoluble dietary fiber (cellulose, hemicellulose, |
| | | and pectin), which contributes to strong fat and |
| | | water retaining abilities. The fruit contains |
| | | moderate length cellulose fibers, contributing to a |
| | | moderate ability to retain fat. Cellulose interlinks |
| | | with hemicellulose and forming a fiber net, |
| | | increasing the surface area of individual fibers, and |
| | | contributing their water and oil retention properties. |
| Texturizer/ | Plant-Only | Tapioca starch is an excellent thickener, binder, |
| gelling | Composition/ | texturizer and stabilizer. Sometimes called tapioca |
| agent | Modified starch | flour, this starch originates from the cassava plant. |
| | replacement | Gelatinized (tapioca) starch can hold a significant |
| | system | amount of water, which helps improve the texture |
| | (ingredients | of many food products, including burgers and |
| | from four plant- | burger mixes. |
| | only categories | The faba bean starch and protein is glossy and |
| | of starches | sticky, and is an important emulsifier, foam |
| | referenced | stabilizer, and contributes to gel formation. Its |
| | in Table 1: | protein constituents include globulin and albumin |
| | legume, | accounting for~25-30% of its content; these |
| | vegetable, cereal | proteins do not contribute as much as the other |
| | and seed | constituents to the gelling capacity. |
| | starches | Quinoa starch is relatively low in amylose content |
| | (e.g., one or | (e.g., 11%), and has very small granules (1 to 3 |
| | more of pea | urn). The starch has unique properties such as low |
| | starch, tapioca | pasting temperature, high freeze-thaw stability, and |
| | starch, faba bean | water holding capacity. The protein from quinoa |
| | starch, sorghum | flour helps provide structure and shape to the |
| | starch, quinoa | system. The protein and starch both contribute to |
| | starch, and/or | the gelling property. |
| | substitutes | Sorghum starch consists mainly amylopectin and |
| | exhibiting the | amylose. While heating, the gelatinization of starch |
| | same or similar | occurs due to hydrogen bonds being broken within |
| | functionality | the starch granule due to water influx, which results |
| | and properties as | in granular swelling, increasing viscosity, which |
| | these | thickens and texturizes the food product. |
| | ingredients) | |
| Shelf life | Plant only shelf | Garlic (Allium sativum) is one of the commonly |
| extender; | life extenders | used plants to enhance flavor. It produces a wide |
| preservative, | comprising any | spectrum of actions which have led to its use as an |
| flavoring | one or more of | antibacterial, antifungal, and antioxidant agent. The |
| agent, | herbs and | presence of allicin, a sulfur-containing compound, |
| stabilizer | spices, including | is responsible for the antimicrobial effects. |
| | garlic extract, | Himalayan pink salt contains substantially higher |
| | Himalayan pink | levels of calcium, iron, magnesium, manganese, |
| | salt; black | potassium, aluminum, barium, silicon, and sulfur, |
| | pepper, oregano, | but lower levels of sodium compared to the white |
| | bay laurel and | table salt. |
| | any substitutes | Black pepper, Piper nigrum, has piperine in higher |
| | of these | amounts that enables the antimicrobial activity. |
| | exhibiting the | Terpenes and flavonoids also contribute to its |
| | same or similar | activity. The essential oil content in black pepper |
| | functionality | mainly consists of caryophyllene (30.3%) and |
| | and properties. | limonene (12.12%), both of which also contribute |
| | | to its antimicrobial activity. |
| | | Oregano, Origanum vulgare, along with its flavor |
| | | imparting action, contributes to antimicrobial and |
| | | antioxidant properties. The major components of |
| | | oregano essential oil are carvacrol, P-fenchyl |
| | | alcohol, thymol, and y-terpinen. These compounds |
| | | have a free radical scavenging effect contributing to |
| | | enhanced shelf life. |
| | | Bay leaf contains 1.3% essential oils that contribute |
| | | to both flavor and shelf life enhancement. These |
| | | oils include primarily eucalyptol (45%) but also |
| | | other terpenes (~12%), terpinyl acetate (8-12%), |
| | | sesquiterpenes (3-4%), |
| | | methyl eugenol (3%), and smaller amounts of other |
| | | a-and P-pinenes, phellandrene, linalool, geraniol, |
| | | terpineol and lauric acid. These compounds exhibit |
| | | radical scavenging and antimicrobial activity. |
| Flavoring | Umami flavor | Meat and other animal-based products can be |
| agent/ | source(s) (one or | replaced in some food products with one or more |
| umami | more of shitake | types of mushrooms without compromising flavor, |
| flavor | and | and can improve nutritional quality by reducing |
| | other mushroom | sodium, calories, saturated fat, and cholesterol |
| | types, onions, | content. Mushrooms impart an “umami” flavor |
| | tomatoes, garlic, | because of their flavor-enhancing compounds, most |
| | lotus stalk, salt, | noticeably the eight carbon (C8) volatile |
| | and substitutes | compounds. Among all C8 compounds, the most |
| | for these | important for mushroom flavor are oct-1-en-3-ol, |
| | exhibiting the | octan-3-ol, octan-3-on and oct-1-en-3-on. |
| | same or similar | Onion (Allium cepa L.) contains high levels of |
| | functionality | flavonoids that enhance the flavor of food products. |
| | and properties) | Onions contribute to the umami flavor of food with |
| | | their high glutamic acid content (~25 to 50 mg/100 g). |
| | | Tomatoes impart a unique flavor, the result of a |
| | | complex mix and interaction among sugars, acids, |
| | | and volatile compounds. They also are high in |
| | | glutamate (~250 mg/100 g). |
| Flavorants/ | One or more | Paprika oleoresin contains a number of carotinoids |
| flavor | flavorants/flavor | and pigments, including, among others, capsanthin |
| enhancers, | enhancers, | and capsorubin, which are strong antioxidants. |
| nutraceutical | nutraceuticals | Paprika is low in capsaicin, the pungent (hot) |
| | (one or more of | compound found in red peppers. |
| | herbs and spices | Methoxypyrazines” in paprika are responsible for |
| | such as cumin, | its vegetative flavor. The sweetness of paprika |
| | paprika, | comes from a sugar content (up to 6%). Paprika has |
| | coriander, black | important bioactive compounds such as |
| | pepper, onion, | carotenoids, quercetin glycosides, and luteolin, all |
| | or a substitute | of which exhibit high antioxidant activity. |
| | for any one or | Onions (Allium cepa L.) contain phytonutrients |
| | more of these | such as: flavonoids, fructooligosaccharides (FOS), |
| | that exhibit the | thiosulfide and other sulfur compounds, which are |
| | same or similar | recognized as important elements of highly |
| | functionality | nutritional molecules. Quercetin is the main |
| | and properties) | flavonoid present in onions, exhibiting antioxidant |
| | | and antimicrobial properties. |
| | | Black pepper (P. nigrum) contains numerous flavor |
| | | compounds and has antimicrobial and antioxidant |
| | | properties. The primary volatile flavor compounds |
| | | include terpenes: monoterpene hydrocarbons (59.2-80.1%) |
| | | and sesquiterpene hydrocarbons (17.0-37.7%) while |
| | | oxygenated terpenoids accounted for about 1.3-2.7%. |
| | | Key odorants of black pepper are a-and P-pinene, |
| | | myrcene, a-phellandrene, limonene, linalool, methyl |
| | | propanal, 2-and 3-methylbutanal, butyric acid, |
| | | germacrene, and 3-methylbutyric acid. The |
| | | spiciness of black pepper comes from Piperine. |
| | | Germacrene is potent, spicy, warm and has a sweet |
| | | aroma. In contrast, limonene is sweet, orange, citrus |
| | | and terpy. The essential oil content in black pepper |
| | | mainly consists of caryophyllene (30.3%) and |
| | | limonene (12.12%) also contribute to antioxidant |
| | | activity. |
| | | Cumin is a seed spice belonging to the family |
| | | umbelliferae. Cumin and products flavored by |
| | | cumin are used in food products and perfumery. |
| | | Cumin contains ~2.3 to 4.8% of volatile oils. The |
| | | characteristic odor of cumin is mainly due to the |
| | | aldehydes present in the seeds, namely, |
| | | cuminaldehyde (45-50%), p-menth-3-en-7-al and |
| | | p-menth-1,3-dien-7-al. Other major compounds |
| | | present in cumin contributing its distinct flavor |
| | | include: cuminal (8-17%), P-pinene (22-27%), |
| | | P-myrcene (1.3-1.75%), p-cymene (23-39%), |
| | | y-terpinene (11-27%), and p-mentha-1,4-dien-7-ol |
| | | (1.0-5.5%). |
| | | Coriander, Coriandrum sativum, has a characteristic |
| | | flavor is due to terpenes. The essential oils present |
| | | in oil glands in the mericarp and the linalool, with |
| | | its floral and pleasant scents also contribute to |
| | | flavor enhancement. Phenolics compounds present |
| | | in the coriander seeds such as gallic acid, caffeic |
| | | acid, ellagic acid, quercetin, kaempferol contribute |
| | | to the antioxidant activity. |
| Thickener, | Methyl | Pea fiber contains insoluble fibers and higher |
| Binding | Cellulose (MC) | protein content, which contribute to its ability to |
| agent, | replacement | hold water. The combination of protein and fiber |
| Stabilizer | system: | also leads to the higher oil absorbing capacity. Peas |
| | ingredients | contain a high amylose starch content (25-29%) |
| | from all five | that enables it to bind water and oil. |
| | categories | Oat fibers retain water, decreases cooking loss, and |
| | (proteins; | it has a neutral flavor. Oats contain 4% (by weight) |
| | fibers from | of P-glucan, a soluble fiber with potential binding |
| | whole grains, | abilities. Oat fiber provides flavor, texture, and |
| | fruits, seeds | mouthfeel of fat. In addition, P-glucan also contains |
| | and vegetables; | hydrocolloids that provide emulsion stability, |
| | starches; and | modifying the gelation process and |
| | vegetable | increasing viscosity. P-glucan forms a porous |
| | binders) | network in a protein-gel matrix, e.g., holding fat |
| | within the | globules in the burger system. |
| | ranges | Chickpeas contain starch and protein, and act as |
| | indicated for the | binder and stabilizer. Chickpea proteins include |
| | replacement | globulins and albumin, which act as binding |
| | system | proteins; these binding proteins constitute 72-85% |
| | | of the weight of the chickpea, and function as |
| | | thickeners and binders by forming protein matrices |
| | | that hold water and fat. |
| | | Quinoa starch is relatively low (e.g., 11%) in |
| | | amylose and appears as small granules (1 to 3 um). |
| | | Quinoa starch has unique properties: low pasting |
| | | temperature, high freeze-thaw stability, and water |
| | | holding capacity. The Quinoa starch granules are |
| | | small, polygonal, and in the range of 0.5-3 um; they |
| | | function as a stabilizer for creating pickering |
| | | emulsions. The proteins from quinoa flour help |
| | | provide structure and shape to the food product. |
| Hydro | Gums and | The main fraction of quince seed gum are high- |
| Colloids- | carrageenan | molecular-weight polysaccharides, the most |
| gelling, | replacement | abundant among them which is d-Xylan, with many |
| emulsifier, | system (one or | glucuronic acid residues. The presence of proteins |
| stabilizer, | more of quince | in quince seed gum (2.2%) affects the interfacial |
| sequestrant | seed, apple, | tension at the oil-water interface, and contributes to |
| | mesquite, | its ability to act as an emulsifier. |
| | almond, or | Almond gum is mainly composed of 92.36% of |
| | substitutes | polysaccharides (dry weight basis) with the major |
| | thereof | sugar composition comprising: arabinose (46.83%), |
| | exhibiting | galactose (35.49%) and uronic acid (5.97%). It also |
| | the same or | contains a small amount of protein (2.45%). |
| | similar | Mesquite gum is a complex carbohydrate and is |
| | properties and | comprised of D-galactose, L-arabinose, D-glucuronate, |
| | functionality) | D-mannose and D-xylose. |
| | | Apple pomace pectin is a low methyl cellulose- |
| | | containing pectin, it forms a thermo-irreversible gel, |
| | | remaining in a gel consistency even at high |
| | | temperatures that would normally melt pectin. |
| | | Pectin aid in the formation of smaller droplet size |
| | | emulsions, showing higher stability and forming a |
| | | gel-like consistency. The action of the insoluble |
| | | fibers in pectin maintain their stability in emulsions |
| | | through pickering mechanism and |
| | | through network formation in the continuous phase; |
| | | this may be favored by stabilization of proteins and |
| | | pectin in the soluble fraction. |
| Flavoring | Flavor enhancer, | Nutritional yeast is a food additive made from a |
| agent | nutritional yeast | single-celled organism, Saccharomyces cerevisiae, |
| | (one or more of | a member of the fungi kingdom. This yeast is |
| | nutritional yeast, | grown on molasses and then harvested, washed, and |
| | cashews and any | dried with heat to kill or deactivate it. |
| | substitute for | Cashews contain esters (methyl 3-methyl butanoate, |
| | either one that | ethyl 3-methyl butanoate, methyl butanoate, ethyl |
| | exhibits the | butanoate, ethyl trans-2-butenoate and methyl 3- |
| | same or similar | methyl pentanoate) which impart a sweet, fruity |
| | functionality | taste and aroma. |
| | and properties) | |
| Leavening | Leavening | Apple cider vinegar is the fermented juice of |
| agent(s) | agent | crushed apples, containing acetic acid, which |
| | replacement | contributes to the leavening action in food products. |
| | system | Dried plums contain about 2% naturally occurring |
| | (ingredients | malic acid, which serves as the natural acid |
| | from all five | component of chemical leavening systems. Dried |
| | categories, | plums can also act as a natural preservative, |
| | including one or | inhibiting microbial spoilage. |
| | more of plum | Vegan buttermilk is made by combining almond |
| | powder, apple | milk with acidulants. The high fat content |
| | cider vinegar, | combined with acids result in curdling. |
| | vegan | |
| | buttermilk, or | |
| | other substitutes | |
| | that exhibit the | |
| | same or similar | |
| | functionality | |
| | and properties in | |
| | the food | |
| | product) | |
| Lipid | Lipid | Black pepper (P. nigrum) with piperine as an active |
| peroxidation | peroxidation | ingredient, holds rich phytochemistry that also |
| inhibitor, | inhibitors (one | includes volatile oil, oleoresins, and alkaloids. |
| antioxidant, | or more of black | Black pepper oleoresins impart taste and exhibit |
| flavor | pepper, bay leaf, | antioxidant properties. They are also used as a |
| enhancer | cumin, or | colorant and a food preservative because of their |
| | substitutes that | antimicrobial properties. P-Caryophyllene, |
| | exhibit the same | limonene, P-pinene, a-pinene, 8-3-carene, |
| | or similar | sabinene, and myrcene are the main components of |
| | functionality | this oil. |
| | and properties) | Bay leaves showed radical scavenging activity due |
| | | to the presence of sesquiterpene lactones, alkaloids, |
| | | and glycosylated flavonoids. The kaempferol |
| | | C-glycoside is the major contributor to antioxidant |
| | | properties. |
| | | Cumin's antioxidant activity is correlated with the |
| | | presence of high polyphenols, mainly flavonoids. |
| | | The essential oils present-carvacrol, anethole, and |
| | | terpineol-also contribute to the function of radical |
| | | scavenging. |
| Color | One or more | Leghaemoglobin is a protein that binds oxygen and |
| retention, | sources of | is found in the root nodules of leguminous plants; it |
| coloring | leghaemoglobin | is often used as an ingredient in some plant- based |
| agent, | (one or more of | meat substitutes. |
| nitrite | beets, red | Red beet-B. vulgaris-is one of the top ten most |
| replacement | radishes | potent antioxidant-rich vegetables. Betalains |
| | or any substitute | (including betanin/betanidin) exhibit high |
| | exhibiting the | antioxidant activity. Red radish and beet powders |
| | same or similar | exhibit antioxidant activity and are high in nitrates. |
| | functionality | Radish powder in particular prevents meats and |
| | and properties as | meat substitutes from changing color. |
| | do these | |
| | ingredients) | |

TABLE 11
Preparation of the ingredient of the Plant-only composition/modified starch
replacement system against each category:

| S. | Category | | |
|---|---|---|---|
| No | Legume | Ingredient | Preparation method |
| 1. | starch | Pea starch | 100 grams (g) of pea flour and 220 milliliters |
| | source(s): | | (ml) of distilled water are combined to create a |
| | | | pea solution that is used for separation. Using a |
| | | | kitchen liquidizer, the suspension for processing |
| | | | the entire seeds is made by mixing for 1 minute. |
| | | | For 10 minutes, the suspension is agitated in a |
| | | | beaker using a paddle agitator. The suspension |
| | | | is then continued stirring for 30 minutes after |
| | | | the pH is changed to 9.0 using 1M Sodium |
| | | | hydroxide (NaOH). It is then centrifuged at |
| | | | 8000-9000 revolution per minute (rpm) for |
| | | | 20-30 minutes. The fractions of proteins are set |
| | | | aside. Moreover, the required separated starch |
| | | | is dried at 40-43° C. before being milled into a |
| | | | fine powder. |
| 2. | Vegetable | Potato starch | Crushed potatoes are cleaned and rinsed. As the |
| | starch | | potato cell structure is broken down by |
| | source(s): | | crushing, the microscopic starch granules can |
| | | | be easily extracted from the potatoes. The |
| | | | crushed material is separated from the starch |
| | | | using water as a medium and squeezed to |
| | | | further filter out the starch slurry water |
| | | | contained in the fiber, to complete the extraction |
| | | | of starch. Thereafter, it is fully panned to |
| | | | completely separate the starch from the fiber; |
| | | | and the pressure-less percolation allows the |
| | | | slurry water to pass through the mesh hole and |
| | | | the fine residue to remain on the net. |
| | | | Subsequently drying and dehydration are used |
| | | | to create powder of potato starch. |
| 3. | Cereal | Sorghum starch | Dry sorghum grains are steeped in a moderate |
| | starch | | alkaline solution for the entire night at a |
| | source(s): | | temperature of 25° C. in order to soften the seeds |
| | | | and dissolve the protein-starch matrix in the |
| | | | seeds. The seeds are repeatedly soaked before |
| | | | being combined. The starch slurry underwent a |
| | | | centrifugation stage at 2000 g for 20 minutes to |
| | | | facilitate starch extraction. The resultant starch |
| | | | is then dried overnight at 40° C. temperature |
| | | | before being stored. |
| 4. | Seed | Quinoa starch | Quinoa starch is extracted using the water |
| | starch | | steeping method. In this procedure, quinoa flour |
| | source(s): | | and seeds are steeped in water in a ratio of 1:6 |
| | | | at a temperature of roughly 4° C. for 24 hours |
| | | | with occasional stirring. After that, the mixture |
| | | | is wet milled for 2 minutes using a lab scale |
| | | | blender. The slurry is further filtered by running |
| | | | it through a number of 300 mesh BSS sieves. |
| | | | The resulting filtrate underwent a 15-minute |
| | | | centrifugation at 5500 rpm. The yellowish layer |
| | | | that is above the starch cake is gently scraped |
| | | | off and removed, and the supernatant is |
| | | | discarded. The recovered starch cake underwent |
| | | | four centrifugal separations after being re- |
| | | | suspended in water. Afterwards, the purified |
| | | | starch is dried for 6 hours in a hot air oven at 40° C. |

### Applications of Plant-Only Composition/Modified Starch Replacement System:

The plant-only composition/modified starch replacement system can be used as an alternative/substitute for starch ingredient in batters, breadings, dairy (fat in reduced-fat yogurts like spoonable, drinkable, and frozen), dessert products, sauces, confectionery like candies, canned foods like soups, meat analogues, plant based burgers and burger mixes, chips, instant pudding, low-fat ice cream, cheese sauces, and powder coated foods like cocoa-dusted almonds etc.

FIG. 2 illustrates a flow diagram of a process of preparing a plant-only composition for a food product according to some embodiments herein. At a step 202, dried powdered/ingredients of (A) about 5%-about 15% weight by weight of one or more Legume starch source(s) comprising one or more of pea starch, lupine starch etc., (B) about 30%-about 50% weight by weight of one or more vegetable starch source(s) comprising any one or more of potato starch, tapioca starch etc., (C) about 10%-about 20% weight by weight of one or more cereal starch source(s) comprising any one or more of sorghum starch, maize (corn) starch etc., (D) about 5%-about 15% weight by weight of one or more seed starch source(s) comprising any one or more of quinoa starch, amaranth starch etc. are mixed together. At a step 204, the mixture then undergoes a low order heat treatment to form a gel at a temperature of between 60° C. and 105° C. At a step 206, by using a blender or a bowl cutter, all of the ingredients in the Plant-only Composition/Modified Starch Replacement System are incorporated with the whole formulation of the intended food product in a gel or dough.

While specific embodiments of the present disclosure have been shown and described in detail to illustrate the inventive principles, it will be understood that the present disclosure may be embodied otherwise without departing from such principles.

While considerable emphasis has been placed herein on the specific features of the preferred embodiment, it will be appreciated that many additional features can be added and that many changes can be made in the preferred embodiment without departing from the principles of the present disclosure. These and other changes in the preferred embodiment of the present disclosure will be apparent to those skilled in the art from the present disclosure herein, whereby it is to be distinctly understood that the foregoing descriptive matter is to be interpreted merely as illustrative of the present disclosure and not as a limitation.

The use of the expression “at least” or “at least one” suggests the use of one or more elements or components, as the use may be in the embodiment of the present disclosure to achieve one or more of the desired objects or results. While certain embodiments of the present disclosure have been described, these embodiments have been presented by way of example only, and are not intended to limit the scope of the present disclosure. Variations or modifications to the formulation of this present disclosure, within the scope of the present disclosure, may occur to those skilled in the art upon reviewing the present disclosure herein. Such variations or modifications are well within the spirit of this present disclosure.

Reference throughout this specification to “some embodiments”, “an embodiment”, or similar language means that a particular feature, structure, or characteristic described in connection with the embodiment is included in at least one embodiment of the present disclosure. Thus, appearances of the phrases “in some embodiments”, “in an embodiment” and similar language throughout this specification may, but do not necessarily, all refer to the same embodiment.

It should be understood that the figures shown above highlighting the functionality and advantages of the present disclosure are presented for example purposes only. The present disclosure is sufficiently flexible and configurable, such that it may be utilized in ways other than that shown in the figures.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A plant-only composition for a food product, comprising:
about 1% to about 20% weight by weight of one or more legume starch sources;
about 20% to about 60% weight by weight of one or more vegetable starch sources;
about 5% to about 25% weight by weight of one or more cereal starch sources; and
about 1% to about 20% weight by weight of one or more seed starch sources, wherein the plant-only composition substitutes a starch ingredient in the food product.

2. The plant-only composition of claim 1, wherein the one or more legume starch sources comprises pea starch, lupine starch, faba bean starch/protein, red lentils starch, lima bean, navy bean, mung bean, black gram flour, lentils flour, garbanzo bean, yellow pea flour, or a combination thereof.

3. The plant-only composition of claim 2, wherein the pea starch comprises about 40% weight by weight of starch and has a neutral color and taste, wherein the pea starch acts as a thickener, an emulsifier, and a gelling agent in the food product as it resists breakdown in high temperatures and its amylose content contributes to water retention properties.

4. The plant-only composition of claim 1, wherein the one or more legume starch sources present in the plant-only composition ranges from about 5% to about 15% weight by weight of the composition.

5. The plant-only composition of claim 1, wherein the one or more legume starch sources present in the plant-only composition ranges from (i) about 1% to about 5% weight by weight of the composition, (ii) about 2% to about 7% weight by weight of the composition, (iii) about 5% to about 10% weight by weight of the composition, (iv) about 5% to about 15% weight by weight of the composition, (v) about 8% to about 13% weight by weight of the composition, (vi) about 10% to about 20% weight by weight of the composition, (vii) about 14% to about 19% weight by weight of the composition, (viii) about 15% to about 20% weight by weight of the composition, or (ix) about 17% to about 20% weight by weight of the composition.

6. The plant-only composition of claim 1, wherein the one or more legume starch sources has a pH of about 5 to 8, a peak viscosity of about 1107 to about 2173 Centipoise (cP), a water holding capacity of about 1.81 to about 2.63 gallons water per gram (g water/g), an amylose content of about 30.61% to about 33.55%, a swelling power of about 1.05 to about 21 g/g depending on the temperature, a moisture content of about 15%, a granule size of about 2 to about 40 micrometres (m), a crystallinity of about 18.9% to about 36.5%, and a gelatinization/pasting temperature of about 60° C. to about 80° C.

7. The plant-only composition of claim 1, wherein the one or more vegetable starch sources comprises at least one of potato starch, cassava starch, tapioca starch, mushroom flour, bamboo starch, sweet potatoes, beets starch, acorn squash starch, pumpkin starch, butternut squash, hubbard starch, or a combination thereof.

8. The plant-only composition of claim 7, wherein the potato starch comprises about 22% weight by weight of amylose content and acts as a gelling agent in the food product.

9. The plant-only composition of claim 1, wherein the one or more vegetable starch sources present in the plant-only composition ranges from about 30% to about 50% weight by weight of the composition.

10. The plant-only composition of claim 1, wherein the one or more vegetable starch sources present in the plant-only composition ranges from (i) about 20% to about 30% weight by weight of the composition, (ii) about 30% to about 40% weight by weight of the composition, (iii) about 30% to about 50% weight by weight of the composition, (iv) about 40% to about 50% weight by weight of the composition, or (v) about 50% to about 60% weight by weight of the composition.

11. The plant-only composition of claim 1, wherein the one or more vegetable starch sources has a pH of about 6 to 8, a bulk density of about 700 kilogram/cubic meter (kg/cc), a moisture content of about 20%, a peak viscosity of about 0.1 to about 0.9 pascal seconds at a shear rate of 115 inverse second (s⁻¹), a water holding capacity of about 415.13% to about 595.26%, an amylose content of about 15% to about 30%, a swelling power of about 20.76% to about 26.92%, a crystallinity ranging from about 20.33% to about 22.25%, and a gelatinization/pasting temperature of about 68.6° C. to about 69.3° C.

12. The plant-only composition of claim 1, wherein the one or more cereal starch sources comprises at least one of sorghum starch, maize starch, wheat starch, barley starch, pearl millet starch, ragi flour, finger millet starch, rice starch, oats starch, rye flour, or a combination thereof.

13. The plant-only composition of claim 12, wherein the sorghum starch comprises more than 25% weight by weight of amylose content and acts as a thickener or a gelling agent in the food product.

14. The plant-only composition of claim 1, wherein the one or more cereal starch sources present in the plant-only composition ranges from about 10% to about 20% weight by weight of the composition.

15. The plant-only composition of claim 1, wherein the one or more cereal starch sources present in the plant-only composition ranges from (i) about 5% to about 10% weight by weight of the composition, (ii) about 7% to about 12% weight by weight of the composition, (iii) about 10% to about 20% weight by weight of the composition, (iv) about 12% to about 17% weight by weight of the composition, (v) about 17% to about 22% weight by weight of the composition, or (vi) about 22% to about 25% weight by weight of the composition.

16. The plant-only composition of claim 1, wherein the one or more cereal starch sources has a swelling power of about 3.3 to about 8.8 g/g, a bulk density of about 513.30 to about 585.10 grams per litre (g/l), a peak viscosity of about 1296 to about 3348 Centipoise (cP), a water holding capacity of about 2.42 to about 3.35 gallons water per gram (g water/g), an amylose content of about 14% to about 30%, a gelatinization/pasting temperature of about 68° C. to about 72° C., and a gelatinization time of about 16.59 minutes to about 19 minutes.

17. The plant-only composition of claim 1, wherein the one or more seed starch sources comprises at least one of quinoa starch, amaranth starch, moringa seed flour, canary seed starch, chia seeds, poppy seeds flour, annatto seed flour, pistachio seed hull flour, sunflower seeds starch, date palm seeds starch, or a combination thereof.

18. The plant-only composition of claim 17, wherein the quinoa starch comprises antioxidants, proteins, and unsaturated fatty acids and acts as a gel, foam or an emulsifier in the food product.

19. The plant-only composition of claim 1, wherein the one or more seed starch sources present in the plant-only composition ranges from about 5% to about 15% weight by weight of the composition.

20. The plant-only composition of claim 1, wherein the one or more seed starch sources present in the plant-only composition ranges from (i) about 1% to about 5% weight by weight of the composition, (ii) about 2% to about 7% weight by weight of the composition, (iii) about 5% to about 10% weight by weight of the composition, (iv) about 5% to about 15% weight by weight of the composition, (v) about 8% to about 13% weight by weight of the composition, (vi) about 10% to about 20% weight by weight of the composition, (vii) about 14% to about 19% weight by weight of the composition, (viii) about 15% to about 20% weight by weight of the composition or (ix) about 17% to about 20% weight by weight of the composition.

21. The plant-only composition of claim 1, wherein the one or more seed starch sources has a swelling power of about 2.05 to about 4.85 g/g, a water holding capacity of about 1.81 to about 2.63 gallons water per gram (g water/g), an amylose content of about 16% to about 30.8%, a gelatinization/pasting temperature of about 54° C. to about 71° C., a bulk density of about 738 to about 842 kilograms per meter cube (kg/m³), a hardness value of about 20.8 grams, a moisture content of about 4.6% to about 25.8%, and a peak viscosity of about 1000 to about 2400 Centipoise (cP).

22. The plant-only composition of claim 1, wherein the food product comprises animal-based burger products, plant-based or plant-derived burger products, burger mixes, meat-based food products, meat alternative food products, frozen food products, baked food products, ice cream and other frozen food products, chocolate, fried food products, and food product mixes.

23. The plant-only composition of claim 1, wherein the plant-only composition acts as a texturizing agent and a volume enhancers in the food product and replaces conventional, non-plant-derived, synthetic or processed additive and ingredient in the food product.

24. The plant-only composition of claim 1, wherein the plant-only composition replaces one or more additives in the food product and maintains structure and texture in the food product by (i) increasing water retention capacities, (ii) increasing pasting, (iii) improving resistance to retrogradation, and (iv) improving stabilization during freezing and thawing cycles.

25. The plant-only composition of claim 1, wherein the plant-only composition, when combined with a binding agent comprising at least one of hydrocolloids, protein and vegetable fibers, produces a resilient matrix to maintain its shape, texture and palatability when heated.

26. The plant-only composition of claim 1, wherein the plant-only composition comprises
about 5% to about 15% weight by weight of one or more legume starch sources;
about 30% to about 50% weight by weight of one or more vegetable starch sources;
about 10% to about 20% weight by weight of one or more cereal starch sources; and
about 5% to about 15% weight by weight of one or more seed starch sources, wherein the plant-only composition substitutes a starch ingredient in the food product.

27. The plant-only composition of claim 1, wherein the plant-only composition comprises
about 5% to about 15% weight by weight of pea starch;
about 30% to about 50% weight by weight of potato starch;
about 10% to about 20% weight by weight of sorghum starch; and
about 5% to about 15% weight by weight of quinoa starch, wherein the plant-only composition substitutes a starch ingredient in the food product.

28. The plant-only composition of claim 1, wherein the plant-only composition present in the food product ranges from about 5% to 15% weight by weight of the food product.

29. The plant-only composition of claim 1, wherein the plant-only composition present in the food product ranges from about 0.5% to about 30% weight by weight of the food product depending on the moisture content of the plant-only composition and that of the final food product.

30. The plant-only composition of claim 1, wherein the plant-only composition present in the food product ranges from about 0.01% to about 1% weight by weight of the food product.

31. A food product, comprising:
about 10% to about 15% weight by weight of a plant-only composition, wherein the plant-only composition comprises
about 1% to about 20% weight by weight of one or more legume starch sources;
about 20% to about 60% weight by weight of one or more vegetable starch sources;
about 5% to about 25% weight by weight of one or more cereal starch sources; and
about 1% to about 20% weight by weight of one or more seed starch sources, wherein the plant-only composition substitutes a starch ingredient in the food product.

32. The food product as claimed in claim 31, wherein the food product comprises
about 10% to about 20% weight by weight of one or more protein sources;
about 5% to about 10% weight by weight of a plant-derived methyl cellulose replacement composition;
about 10% to about 12% weight by weight of one or more plant-derived oils;
about 10% to about 15% weight by weight of a plant-derived gums and carrageenan replacement composition; and
about 0.5% to about 1% weight by weight of a plant-derived leavening agent replacement composition.

33. The food product as claimed in claim 32, wherein the food product comprises
about 1% to about 2% weight by weight of one or more plant-derived shelf life extenders;
about 0.5% to about 2% weight by weight of a plant-derived umami flavor;
about 0.5% to about 1% weight by weight of one or more plant-derived flavorants/flavor enhancers, or nutraceuticals;
about 1% to about 2% weight by weight of a second plant-derived flavor enhancer;
about 0.5% to about 2% weight by weight of one or more mineral salts;
about 5% to about 10% weight by weight of one or more plant-derived binding agents;
about 1% to about 2% weight by weight of one or more plant-derived leghemoglobin sources; and
about 0.5% to about 2% weight by weight of one or more plant-derived lipid peroxidation inhibitors.

34. The food product of claim 31, wherein the one or more protein sources comprises at least one of pea, mushroom, quinoa, chickpeas, or a combination thereof.

35. The food product of claim 31, wherein the plant-derived methyl cellulose replacement composition comprises at least one of proteins, fibers from whole grains, fruits, seeds, vegetables, starches, vegetable binders, or a combination thereof.

36. The food product of claim 31, wherein the one or more plant-derived oils comprises at least one of sunflower oil, coconut oil, flaxseed oil, rice bran oil, other oil comprising at least one of Omega-3 fatty acids, Monounsaturated fatty acids (MUFA), or Medium-chain triglycerides (MCTs), or a combination thereof.

37. The food product of claim 31, wherein the plant-derived gums and carrageenan replacement composition comprises at least one of quince seed, apple, mesquite, almonds, or a combination thereof.

38. The food product of claim 31, wherein the plant-derived leavening agent replacement composition comprises at least one of plant-derived fibers, fruit pectin, fruit acids, plant-derived starches, cereal sources, or a combination thereof.

39. The food product of claim 31, wherein the plant-derived leavening agent replacement composition comprises at least one of plum powder, apple cider vinegar, vegan buttermilk, or a combination thereof.

40. The food product of claim 32, wherein the one or more plant-derived shelf life extenders comprises at least one of garlic, black pepper, oregano, bay laurel, or a combination thereof, wherein the plant-derived umami flavor comprises at least one of shitake and other mushrooms, tomatoes, garlic, lotus stalk, onions, salt, or a combination thereof, wherein the one or more plant-derived flavorants/flavor enhancers, or nutraceuticals comprises at least one of cumin, coriander, paprika, black pepper, or a combination thereof, wherein the second plant-derived flavor enhancer comprises at least one of nutritional yeast, cashew nuts, or a combination thereof, wherein the one or more mineral salts comprises at least one of Himalayan pink salt, sea salt, or a combination thereof, wherein the one or more plant-derived binding agents comprises at least one of chickpeas, oat fiber, aquafaba, sugar beet pectin, or a combination thereof, wherein the one or more plant-derived leghemoglobin sources comprises at least one of beets, soy, red radish, or a combination thereof, wherein the one or more plant-derived lipid peroxidation inhibitors comprises at least one of black pepper, bay leaf, cumin, or a combination thereof.

41. A plant-only modified starch replacement system for a food product comprising a plant-only composition, wherein said plant-only composition comprises:
about 1% to about 20% weight by weight of one or more legume starch sources;
about 20% to about 60% weight by weight of one or more vegetable starch sources;
about 5% to about 25% weight by weight of one or more cereal starch sources; and
about 1% to about 20% weight by weight of one or more seed starch sources, wherein the plant-only composition substitutes a starch ingredient in the food product.
